(19) United States
(12) Patent Application Publication
(10) Pub. No.: US 2022/0188667 A1
(43) Pub. Date: Jun. 16, 2022

(54) VEHICLE PREDICTION MODULE EVALUATION AND TRAINING

(71) Applicant: Woven Planet North America, Inc., Los Altos, CA (US)

(72) Inventors: Michael Burisch, Munich (DE); Ana Sofia Rufino Ferreira, Berkeley, CA (US); Wilhelm Richert, Zorneding (DE)

(73) Assignee: Woven Planet North America, Inc., Los Altos, CA (US)

(21) Appl. No.: 17/122,822

(22) Filed: Dec. 15, 2020

(51) Int. Cl. G06N 5/04; G06N 20/00; G07C 5/08

(52) U.S. Cl. CPC G06N 5/04; G07C 5/085; G06N 20/00

(57) ABSTRACT

A method includes accessing perception data generated based on first sensor data and generating first prediction data using a prediction module based on the perception data. The method includes capturing second sensor data while the vehicle is operating according to a first planned trajectory based on the first prediction data and a path planning parameter. The method includes generating a simulation for evaluating the prediction module, including generating second prediction data based on the second sensor data and generating a second planned trajectory. The method includes, subsequent to determining that a difference between the first planned trajectory and the second planned trajectory fails to satisfy predetermined prediction criteria, identifying an object for which the prediction module underperforms relative to the predetermined prediction criteria and updating the prediction module based on the identified object and data associated with the second prediction data.

### TECHNICAL FIELD

This disclosure relates generally to autonomous or semi-autonomous vehicles, and, more specifically, to vehicle prediction module evaluation and training for autonomous or semi-autonomous vehicles.

### BACKGROUND

Autonomy systems for an autonomous or semi-autonomous vehicle may generally include one or more systems or subsystems that may be utilized to perceive the surroundings of the vehicle at a given point in time, to accurately predict what is to happen at a next point in time with respect to the surroundings of the vehicle, and to generate a planned trajectory for allowing the vehicle to safely and comfortably navigate residential and urban environments and in accordance with the local and/or regional traffic laws of those residential and urban environments. For example, while operating in the autonomous-driving mode, the one or more systems or subsystems may generally include a perception system that generates perception data from data captured by sensors of the vehicle, a prediction system that may receive the perception data and generate prediction data with respect to one or more agents based on the perception data, and a trajectory planner that may generate a planned trajectory in response to the prediction data generated by the prediction system.

In some instances, the trajectory planner may generate a planned trajectory that includes a discomforted braking (e.g., a hard braking) or a disengagement from operating in the autonomous-driving mode based on prediction data. However, the discomforted braking or disengagement may be unwarranted, for example, because the prediction data with respect to one or more agents within the environment of the vehicle was either incorrect or less precise than desired. For example, the prediction system may predict that a pedestrian would enter into a crosswalk within the next 5-10 seconds, and the pedestrian instead remained on a sidewalk. In such an instance, the trajectory planner would have generated a planned trajectory including a discomforted braking or a disengagement, although in actuality that discomforted braking or disengagement would have turned out to be unwarranted. Still, there may also be certain driving scenarios in which, even if the prediction system is accurate, the planned trajectory may nevertheless include an undesirable discomforted braking or disengagement because of the inherent unpredictability with respect to one or more agents within the environment of the vehicle. It may be thus useful to provide techniques to improve prediction systems for autonomous or semi-autonomous vehicles.

### BRIEF DESCRIPTION OF THE DRAWINGS

FIGS. 1A, 1B, and 1C illustrate example driving scenarios utilizing known prediction data.

FIG. 2A illustrates an example block diagram of a prediction training framework, including a known prediction module.

FIG. 2B illustrates an example block diagram of a prediction training framework, including a known prediction module and simulated agents.

FIG. 3A illustrates an example driving scenario utilizing known prediction data.

FIG. 3B illustrates another example driving scenario utilizing known prediction data.

FIG. 4A illustrates another example driving scenario utilizing known prediction data.

FIG. 4B illustrates another example driving scenario utilizing known prediction data.

FIG. 5 illustrates another example driving scenario utilizing known prediction data.

FIG. 6A illustrates a flow diagram of a method for generating known prediction data and providing to a planning module to generate a planned trajectory that may be utilized for the evaluation and training of the prediction module.

FIG. 6B illustrates a flow diagram of a method for generating known prediction data and providing to a planning module to generate a planned trajectory that may be utilized for the learning, evaluation, and training of the prediction module.

FIG. 7 illustrates an example block diagram of a transportation management environment.

FIG. 8 illustrates an example of a computing system.

### DESCRIPTION OF EXAMPLE EMBODIMENTS

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. In addition, the embodiments disclosed herein are only examples, and the scope of this disclosure is not limited to them. Certain embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, may be claimed in another claim category, e.g., system, as well. The dependencies or references back in the attached claims are chosen for formal reasons only. However, any subject matter resulting from a deliberate reference back to any previous claims (in particular multiple dependencies) may be claimed as well, so that any combination of claims and the features thereof are disclosed and may be claimed regardless of the dependencies chosen in the attached claims. The subject-matter which may be claimed comprises not only the combinations of features as set out in the attached claims but also any other combination of features in the claims, wherein each feature mentioned in the claims may be combined with any other feature or combination of other features in the claims. Furthermore, any of the embodiments and features described or depicted herein may be claimed in a separate claim and/or in any combination with any embodiment or feature described or depicted herein or with any of the features of the attached claims.

Autonomy systems for an autonomous or semi-autonomous vehicle may generally include one or more systems or subsystems that may be utilized to perceive the surroundings of the vehicle at a given point in time, to accurately predict what is to happen at a next point in time with respect to the surroundings of the vehicle, and to generate a planned trajectory for allowing the vehicle to safely and comfortably navigate residential and urban environments and in accordance with the local and/or regional traffic laws of those residential and urban environments. For example, while operating in the autonomous-driving mode, the one or more systems or subsystems may generally include a perception system that generates perception data from data captured by sensors of the vehicle, a prediction system that may receive the perception data and generate prediction data with respect to one or more agents based on the perception data, and a planning module that may generate a planned trajectory in response to the prediction data generated by the prediction system.

In some instances, the planning module may generate a planned trajectory that includes a discomforted braking (e.g., a hard braking) or a disengagement from operating in the autonomous-driving mode based on prediction data. However, the discomforted braking or disengagement may be unwarranted, for example, because the prediction data with respect to one or more agents within the environment of the vehicle was either incorrect or less precise than desired. For example, the prediction system may predict that a pedestrian would enter into a crosswalk within the next 5-10 seconds, and the pedestrian instead remained on a sidewalk. In such an instance, the planning module would have generated a planned trajectory including a discomforted braking or a disengagement, although in actuality that discomforted braking or disengagement would have turned out to be unwarranted. Still, there may also be certain driving scenarios in which, even if the prediction system is accurate, the planned trajectory may nevertheless include an undesirable discomforted braking or disengagement because of the inherent unpredictability with respect to one or more agents within the environment of the vehicle.

Specifically, because of the inherent unpredictability with respect to one or more agents within the environment of the vehicle, it may not be possible to achieve errorless or perfect predictions with respect to one or more agents within the environment of the vehicle at any given point in time. However, because the planned trajectories generated by the planning module may be particularly sensitive and correspondent to the prediction data consumed by the planning module, it may be useful to identify particular driving scenarios and particular dynamic agents with respect to the identified driving scenarios for which the prediction system may be improved by increased prediction accuracy (e.g., already-known-be-correct prediction data) and to distinguish those from driving scenarios or other agents for which some allowable prediction error or imperfection may have only marginal impact to the trajectory planning performed by the planning module. Indeed, by identifying the particular driving scenarios and the particular dynamic agents with respect to those identified driving scenarios for which the prediction system may be improved by errorless or near perfect prediction data, and by further distinguishing those from driving scenarios or other agents for which some prediction error or imperfection may have only marginal impact to the trajectory planning, the prediction system may be trained based on the particular driving scenarios and the particular dynamic agents with respect to those identified driving scenarios for which the performance of the prediction system may be improved. Additionally, the errorless or near perfect prediction data may further allow for the identification of driving scenarios or other agents within an environment for which the prediction module performs well, and thus provides an indication that, for these certain driving scenarios or agents the trajectory planning or other systems of the autonomous driving stack may need improvement and/or additional training and retraining.

Accordingly, the present techniques include an offline prediction training framework that utilizes perception data captured after a point in time (e.g., in the future) in which an online prediction module generates prediction data, and generates known prediction data (e.g., prediction data already known be correct) based thereon. The known prediction module may provide the known prediction data to a planning module to determine what the planning module would perform based on generated prediction data (as generated by the base prediction module) as compared against the known prediction data. Thus, utilizing the determined deviation between the planned trajectory generated based on the generated or unknown prediction data and the planned trajectory generated based on the known prediction data, the present techniques may allow developers to evaluate the performance of the base prediction module, and to determine one or more driving scenarios for which the prediction module may include additional training to improve the performance of the prediction module. In certain embodiments, the known prediction module may also allow developers to alter or supplement one or more aspects of the input perception data in order to further evaluate the prediction module. For example, the known prediction module may evaluate the performance of agent-specific prediction modules with respect to each of a number of different agent types (e.g., vehicle versus pedestrian versus cyclist, etc.) and their respective positions with respect to the vehicle. The known prediction module may also allow developers to alter the prediction data consumed by the planning module to evaluate its impact on the planning module, as measured by a predetermined metric (e.g., a discomforted braking, a disengagement, or a potential collision) in order to determine exactly how accurate the prediction data may be to prevent an undesirable autonomy event, such as a discomforted braking or a disengagement. The known prediction module may also identify certain driving scenarios to be introduced to a training dataset for the prediction module by evaluating which of an aggregate set of driving scenarios included inaccurate predictions that may materially affect the planning module to generate trajectories with an adverse impact to a predetermined metric (e.g., collision, discomforted braking, disengagement).

Indeed, in certain embodiments, the prediction training framework may access perception data generated based on first sensor data captured by one or more sensors associated with a vehicle. For example, in one embodiment, the perception data may be associated with an environment external of the vehicle. The prediction training framework may then generate first prediction data with respect to the environment using a prediction module of the vehicle based on the perception data. In certain embodiments, while the vehicle is operating according to a first planned trajectory based on the first prediction data and a path planning parameter, the prediction training framework may then capture second sensor data of the environment by using the one or more sensors associated with the vehicle. In certain embodiments, the prediction training framework may then generate second prediction data (e.g., already-known-be-correct prediction data) with respect to the environment based on the second sensor data. In certain embodiments, the prediction training framework may then generate a second planned trajectory for the vehicle based on the second prediction data and the same path planning parameter. In certain embodiments, the prediction training framework may generate the second prediction data by generating a predicted trajectory for a first object within the environment. For example, in one embodiment, the prediction training framework may determine an amount of time into the future the predicted trajectory for the first object is to extend and generate the second planned trajectory for the vehicle based on the determined amount of time. Further, in one embodiment, in generating the second planned trajectory, the prediction training framework may select between the first prediction data, the second prediction data, or a combination of the first prediction data and the second data based on a predetermined prediction data filtering criteria.

In certain embodiments, the prediction training framework may then determine a difference between the first planned trajectory and the second planned trajectory. In certain embodiments, the prediction training framework contemplates that using the same path planning parameter to generate both the first and second planned trajectories may be used to isolate for the first and second prediction data as the only difference between the first and second planned trajectories. In certain embodiments, in response to determining that the difference fails to satisfy predetermined prediction (e.g., determined based on a braking parameter, a disengagement parameter, a jerk parameter, a lateral acceleration parameter, a ride smoothness parameter, or a collision parameter), the prediction training framework may identify, based on the second prediction data and the second planned trajectory, a first object within the environment for which the prediction module underperforms and update the prediction module based on the identified first object and data associated with the second prediction data. For example, in one embodiment, the prediction system may identify the first object by identifying a dynamic object of a number of dynamic objects identified within the environment for which the prediction module underperforms by a greatest amount.

In other embodiments, in response to determining that the difference fails to satisfy predetermined prediction criteria, the prediction training framework may also identify, based on the second prediction data and the second planned trajectory, a second object within the environment for which the prediction system underperforms. For example, in some embodiments, the prediction training framework may determine that the prediction module underperforms by a greater amount with respect to the first object than with respect to the second object and update the prediction module based on the first object and the data associated with the second prediction data. In one embodiment, the prediction training framework may update the prediction module by providing a prediction training dataset to the prediction module to train the prediction module to generate prediction data so as to reduce the difference between the first planned trajectory and the second planned trajectory.

In certain embodiments, the prediction training framework may also generate third prediction data with respect to the environment based on the second sensor data and first simulated data. For example, in one embodiment, the third prediction data may include prediction data associated with a first object. The prediction training framework may then generate a third planned trajectory for the vehicle based on the third prediction data. In certain embodiments, the prediction training framework may then generate fourth prediction data with respect to the environment based on the second sensor data and second simulated data. For example, in one embodiment, the fourth prediction data may include prediction data associated with a second object different from the first object. The prediction training framework may then generate a fourth planned trajectory for the vehicle based on the fourth prediction data and determine a difference between the third planned trajectory and the fourth planned trajectory. In certain embodiments, in response to determining that the difference between the third planned trajectory and the fourth planned trajectory fails to satisfy the predetermined prediction criteria (e.g., one of the third planned trajectory or the fourth planned may have resulted in a discomforted braking, a disengagement, or a potential collision), identifying one of the first object or the second object for which the prediction module underperforms by a greatest amount. In one embodiment, the first simulated data may include a first jitter adjustment with respect to the first object and the second simulated data may include a second jitter adjustment with respect to the second object. In certain embodiments, the prediction training framework may utilize at least one of the first jitter adjustment or the second jitter adjustment to determine an accuracy to sensitivity ratio between the prediction module and a planning module of the vehicle.

In this way, the present techniques provide an offline prediction training framework that utilizes perception data captured after a point in time (e.g., in the future) in which an online generated or unknown prediction system generates prediction data, and generates known prediction data (e.g., prediction data already known be correct) based thereon. The known prediction system may provide the known prediction data to a planning module to determine what the planning module would perform based on generated or unknown prediction data (as generated by the traditional prediction system) as compared against the known prediction data. Thus, utilizing the determined deviation between the planned trajectory generated based on the generated or unknown prediction data and the planned trajectory generated based on the known prediction data, the present techniques may allow the prediction training framework to evaluate the performance of the prediction module, and to identify particular driving scenarios and particular dynamic agents with respect to the identified driving scenarios for which the prediction module may be improved by increased prediction accuracy (e.g., already-known-be-correct prediction data) and to distinguish those from driving scenarios or other agents for which some allowable prediction error or imperfection may have only marginal impact to the trajectory planning performed by the planning module. Indeed, by identifying the particular driving scenarios and the particular dynamic agents with respect to those identified driving scenarios for which the prediction system may be improved by errorless or near perfect prediction data, and by further distinguishing those from driving scenarios or other agents for which some prediction error or imperfection may have only marginal impact to the trajectory planning, the prediction system may be trained based on the particular driving scenarios and the particular dynamic agents with respect to those identified driving scenarios for which the performance of the prediction system may be improved.

As used herein, an “autonomy event” or an “autonomous-driving event” may refer to any event or action in which a supervisory driver (e.g., human driver or other operator) and/or autonomous or semi-autonomous vehicle itself overrides an autonomous-driving mode and cause the autonomous or semi-autonomous vehicle to operate in an operator-driving mode (e.g., the supervisor driver assumes or reassumes control of driving the autonomous or semi-autonomous vehicle by instruction of the vehicle or at the discretion of the supervisor). For example, the “autonomy event” or an “autonomous-driving event” may refer to a discomforted braking, a disengagement, and/or other event or action in which a supervisory driver and/or the autonomous or semi-autonomous vehicle itself performs in response to the supervisor perceiving one or more potential hazardous conditions (e.g., based on weather and/or road conditions, road and traffic communications, amount of agents within or nearby the drive path of the vehicle, particular driving laws within one or more local jurisdictions, and so forth) or in response to receiving one or more warnings from the autonomous or semi-autonomous vehicle that the vehicle is unable able to proceed safely (e.g., based on weather and/or road conditions, road and traffic communications, amount of agents within or nearby the drive path of the vehicle, particular driving laws within one or more local jurisdictions, and so forth).

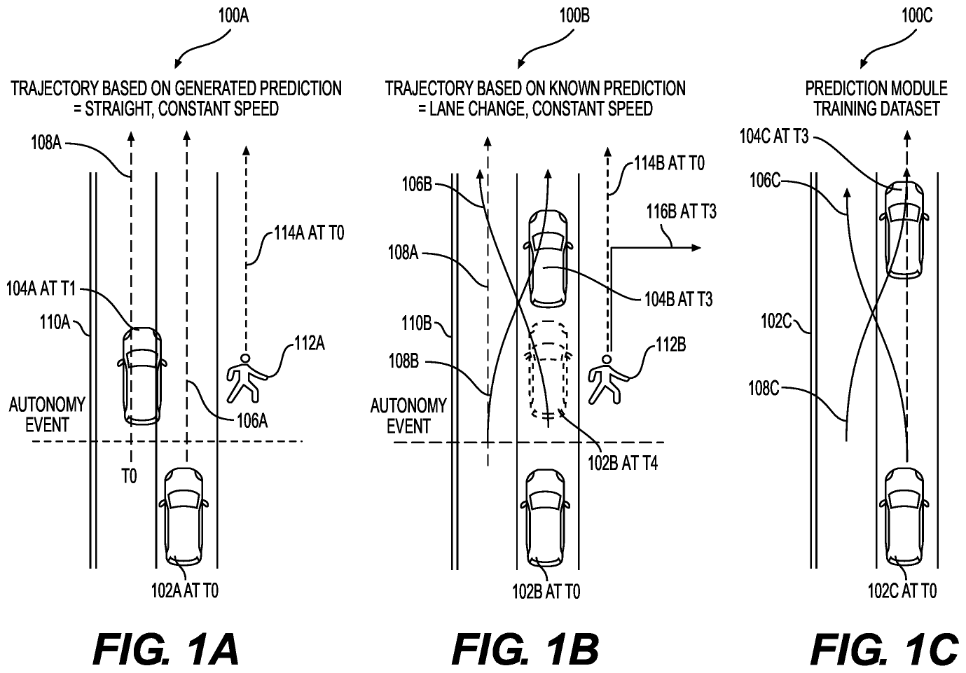

With the forgoing in mind, it may be useful to describe an example driving scenarios of autonomous-driving followed by an autonomy event and prediction module evaluation and training, as illustrated, for example, by FIGS. 1A, 1B, and 1C. Specifically, FIGS. 1A, 1B, and 1C illustrate one or more running examples of autonomous-driving mode scenarios 100A, 100B, and 100C in which the vehicles 102A, 102B, and 102C and each has a respective planned trajectory based on generated prediction data and known prediction data with respect to agents 104A, 104B, 104C, 112A, 112B, and 112C, in accordance with the presently disclosed embodiments. For example, each of the example autonomous-driving mode scenarios 100A, 100B, and 100C illustrates the planned trajectories 106A, 106B, and 106C for the vehicles 102A, 102B, and 102C as the vehicles 102A, 102B, and 102C travel along roadways 110A, 110B, and 110C. In certain embodiments, as illustrated by the example driving scenario 100A of FIG. 1A, the planned trajectory 106A for the vehicle 102A may include a constant velocity and a constant steering angle, such that the vehicle 102A may travel straight and at a constant velocity along the roadway 110A while operating in the autonomous-driving mode. The predicted trajectories 108A and 114A for the respective agents 104, 112A and 112A in the driving scenario 100A may also include a constant velocity and a constant steering angle at T0. In the driving scenario 100A, the planned trajectory 106A and the predicted trajectory 108A may be generated by a planning module consuming generated prediction data.

As depicted, however, because the agent 104A may have started to straddle the lane boundaries of the roadway 110A, the planned trajectory 106A may include an autonomy event (e.g., a discomforted braking, a disengagement, and so forth) that occurs at a given point in time while the vehicle 102A operating in the autonomous-driving mode. For example, in the example autonomous-driving mode scenario 100A, an autonomy event (e.g., a discomforted braking, a disengagement, and so forth) may occur at a point during the planned trajectory 106A in which the vehicle 102A, for example, is approaching the agent 104A (e.g., another vehicle at traveling at a constant velocity), but veering at least partially over the lane boundary separating the vehicle 102A and the agent 104A. In such a case, a supervisory driver of the vehicle 102A may have disengaged and/or the autonomous compute system of the vehicle 102A may have performed a discomforted braking (e.g., a hard-braking) because the agent 104A was deviating too much from the predicted trajectory 108A determined by the vehicle 102A at T0, and that the planned trajectory 106A and the predicted trajectory 108A would cause the vehicle 102A to collide with the agent 104A at a later point during the planned trajectory 106A (e.g., if the agent 104A continued deviating from the predicted trajectory 108A).

In certain embodiments, as illustrated by the example simulated driving scenario 100B of FIG. 1B, the planned trajectory 106B for the vehicle 102B may include a constant velocity and a varying steering angle, such that the vehicle 102B may travel straight for some time and at a constant velocity before making a lane change to the adjacent lane along the roadway 110B at T4. For example, as will be discussed in greater detailed below, the example simulated driving scenario 100B of FIG. 1B may be an offline simulation of the driving scenario 100A. Specifically, the planned trajectory 106B may be generated by the planning module based on known prediction data (e.g., prediction data already known be correct) with respect to the predicted trajectory 108B for the agent 104B and the predicted trajectory 114B for the agent 112B, in accordance with the presently disclosed embodiments. As depicted, the known predicted trajectory 108B for the agent 104B may include an increasing velocity and varying steering angle, such that the agent 104B may perform a lane change at T3 (e.g., overtaking the vehicle 102B). Similarly, the known predicted trajectory 116B for the agent 112B may include a straight path and a right turn at T3. In accordance with the presently disclosed embodiments, based on the prediction data already known be correct (e.g., predicted trajectory 108B for the agent 112B), the planning module may generate a planned trajectory 106B that includes a constant velocity and varying steering angle to perform a lane change at T4 (e.g., to the opposing lane of the roadway 110B). As it may be further appreciated from the driving scenario 100B, even though the known prediction data based predicted trajectory 116B for the agent 112B may deviate from the generated prediction data based predicted trajectory 114B, because the agent 112B is traveling (e.g., walking, jogging), for example, on a sidewalk or other area not within the drive path of the vehicle 102B, the predicted trajectory 116B may not materially and adversely impact the planned trajectory 106B generated based on the known prediction data (e.g., predicted trajectory 108B).

For example, in certain embodiments, as illustrated by the example driving scenario 100C of FIG. 1C, the prediction module of the vehicle 102C may be trained based on the planned trajectory 106C (e.g., corresponding to the planned trajectory 106B) and the projected trajectory 108C (e.g., corresponding to the projected trajectory 108B) determined with respect to the agent 104C, which are each generated based on known prediction data (e.g., prediction data already known be correct). Indeed, in accordance with the presently disclosed embodiments, a known prediction system may provide known prediction data to a planning module of the vehicle 102C to determine the difference between the planned trajectory 108A generated based on generated prediction data and the planned trajectory 108B. Thus, utilizing the determined deviation between the planned trajectory 108A and the planned trajectory 108B, the present techniques may allow the offline prediction training framework to evaluate the performance of the prediction module of the vehicle 102C, and to determine certain driving scenarios (e.g., driving scenario 100B corresponding to the predicted trajectory 108B with respect to the agent 104B) to be introduced to a prediction training dataset for the prediction module. Furthermore, as previously noted, even though the known prediction data based predicted trajectory 116B for the agent 112B may deviate from the generated prediction data based predicted trajectory 114B, because the agent 112B is traveling (e.g., walking, jogging), for example, on a sidewalk and not within the drive path of the vehicle 102B, the predicted trajectory 116B may be determined as not being materially and adversely impactful to the planned trajectory 106B generated by the planning module based on the known prediction data (e.g., predicted trajectory 108B).

Thus, as the forgoing elucidates, the present embodiments may provide an offline prediction training framework that utilizes perception data captured after a point in time (e.g., in the future) in which an online generated or unknown prediction module generates prediction data, and generates known prediction data (e.g., prediction data already known be correct) based thereon. Thus, utilizing the determined deviation between the planned trajectory generated based on the generated or unknown prediction data and the planned trajectory generated based on the known prediction data, the present techniques may allow the prediction training framework to evaluate the performance of the prediction module, and to identify particular driving scenarios and particular dynamic agents with respect to the identified driving scenarios for which the prediction module may be improved by increased prediction accuracy (e.g., already-known-be-correct prediction data) and to distinguish those from driving scenarios or other agents for which some allowable prediction error or imperfection may have only marginal impact to the trajectory planning performed by the planning module. Indeed, by identifying the particular driving scenarios and the particular dynamic agents with respect to those identified driving scenarios for which the prediction system may be improved by errorless or near perfect prediction data, and by further distinguishing those from driving scenarios or other agents for which some prediction error or imperfection may have only marginal impact to the trajectory planning, the prediction system may be trained based on the particular driving scenarios and the particular dynamic agents with respect to those identified driving scenarios for which the performance of the prediction system may be improved.

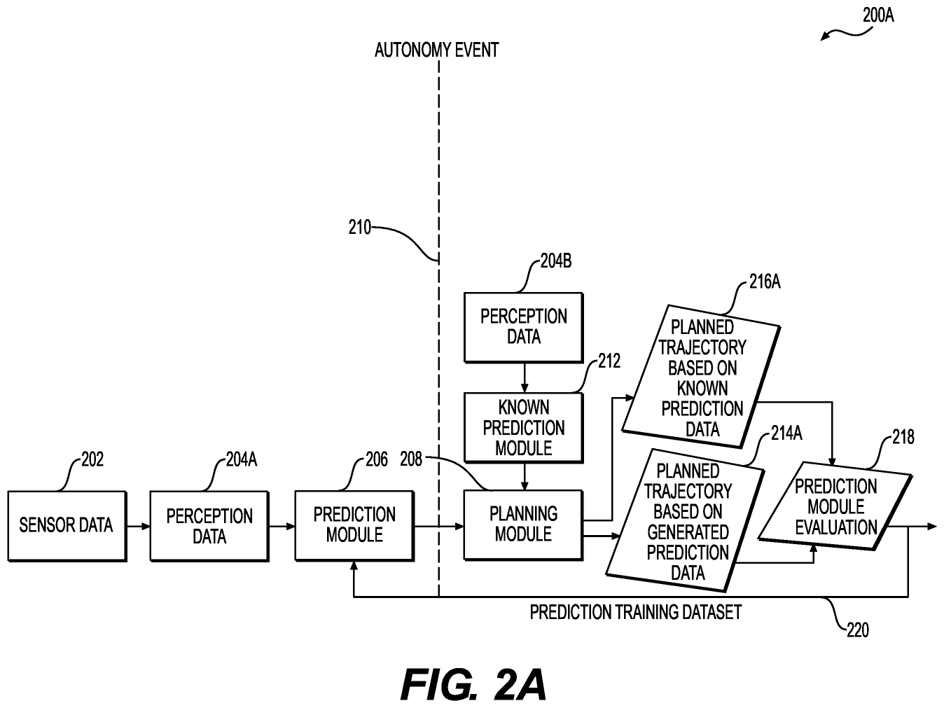

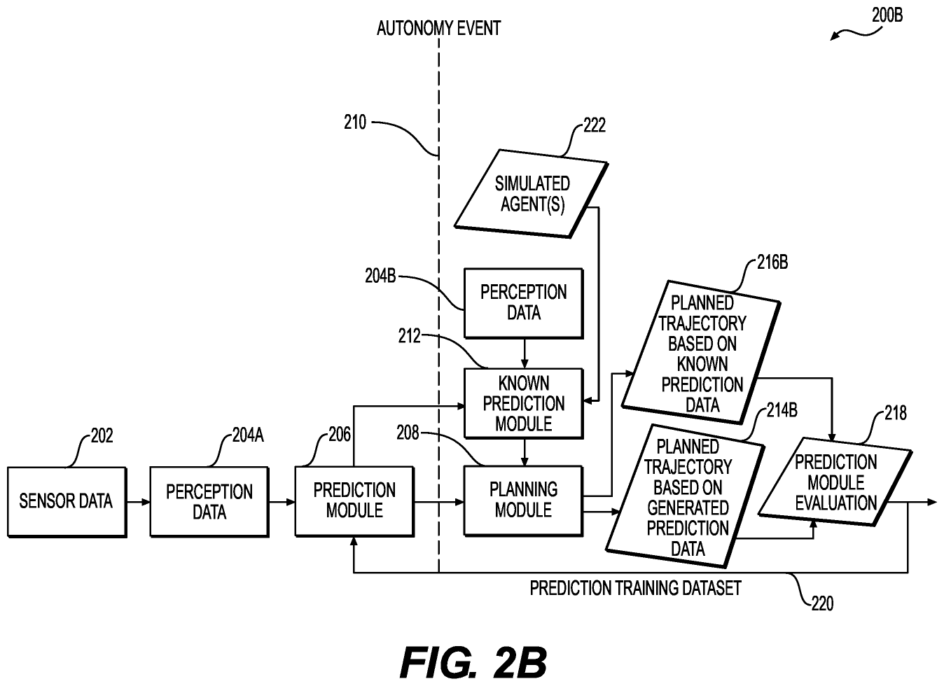

FIG. 2A and FIG. 2B illustrate example block diagrams of prediction training frameworks 200A and 200B that may be utilized to generate known prediction data (e.g., prediction data already known be correct) and evaluate and train a prediction module 206 based on the impact that the known prediction data on the trajectory planning of the planning module 208, in accordance with the presently disclosed embodiments. Indeed, as will be discussed in further detail below, the prediction training framework 200A may illustrate one embodiment in which known prediction data may be generated by a known prediction module 212 and utilized to evaluate and train the prediction module 206. Similarly, the prediction training framework 200B may illustrate another embodiment in which known prediction data may be generated, adjusted and tuned by developers to determine how sensitive the trajectory planning of the planning module 208 may be to changes to the known prediction data, and/or blended with prediction data generated by the prediction module 206 to further evaluate and train the prediction module 206 for various complex driving scenarios.

For example, as depicted by FIG. 2A, in some embodiments, the prediction training framework 200A may include sensor data 202 may obtain and pre-process sensor/telemetry data. Such data may be captured by any suitable sensors of the vehicle 102A. In certain embodiments, the vehicle 102A may include, for example, one or more LiDAR sensors that may be utilized to transmit pulsed laser beams in multiple directions and measure the reflected signal from agents 104, 112 or other objects surrounding the vehicle 102. The time of flight (ToF) of the light signals may be used to measure the distance or depth of the agents 104, 112 or other objects from the LiDAR. In some embodiments, the vehicle 102A may include optical cameras pointing in different directions to capture images (e.g., still images, video images) of the surrounding of the vehicle 102. In certain embodiments, radars may also be used by the vehicle 102A for detecting other vehicles and/or other potential obstructions at a distance. As further examples, the vehicle 102A may be equipped with, for example, one or more ultrasonic sensors, electromagnetic imaging sensors, or thermal imaging sensors for close range object detection (e.g., parking and obstacle detection). The vehicle 102A may further include one or more infrared cameras for object detection when operating within, for example, low-lighting and/or dark locations. In certain embodiments, sensor data 202 may suppress noise in the sensor data or normalize the sensor data. The sensor data 202 may be include sensor information from any suitable sensors and/or modules configured to sense information from the environment surrounding the vehicle 102.

In certain embodiments, the perception data 204A may be suitable for correlating and fusing the data from the different types of sensors for the sensor data 202 to model the contextual environment of the vehicle 102. The perception data 204A may utilize information extracted by multiple independent sensors to provide information that would not be available from any single type of sensors. In some embodiments, combining data from multiple sensor types allows the perception data 204A to leverage the strengths of different sensors and more accurately and precisely perceive the environment. For example, image-based object recognition may not work well in low-light conditions. This may be compensated by sensor data from LiDAR or radar, which are effective sensors for measuring distances to targets in low-light conditions. For example, image-based object recognition may mistakenly determine that an object depicted in a poster is an actual three-dimensional (3D) object in the environment. However, if depth information from a LiDAR is also available, the perception data 204A may utilize that additional information to correctly determine that the object in the poster is actually a two-dimensional (2D) object, for example.

In certain embodiments, the perception data 204A may process the available data (e.g., sensor data, data from a high-definition map, and so forth) to derive information about the contextual environment. For example, perception data 204A may include one or more agent modelers (e.g., object detectors, object classifiers, or machine-learning (ML) models trained to derive information from the sensor data) to detect and/or classify agents 104, 112 present in the environment of the vehicle 102A (e.g., other vehicles 102, pedestrians, bicyclists, wildlife, vegetation, or any of various other moving and/or stationary objects). The perception data 204A may also determine various characteristics of the agents 104, 112. For example, perception data 204A may track the velocities, moving directions, accelerations, trajectories, relative distances, or relative positions of these agents 104, 112. In certain embodiments, the perception data 204A may also leverage information from a high-definition map. The high-definition map may include, for example, a precise 3D model of the environment, including buildings, curbs, street signs, traffic lights, and any stationary fixtures in the environment. In certain embodiments, GPS data and/or image-based localization techniques (e.g., simultaneous localization and mapping, or SLAM), the perception data 204A may determine the pose (e.g., position and orientation) of the vehicle 102A or the poses of the sensors of the vehicle 102A within the high-definition map. The pose information, in turn, may be used by the perception data 204A to query the high-definition map and determine what agents 104, 112 are expected to be in the environment.

In certain embodiments, perception data 204A may utilize the sensor data from one or more types of sensors and/or information derived therefrom to generate a representation of the contextual environment of the vehicle 102. For example, the representation of the external environment may include agents 104, 112 such as other vehicles 102, curbs, debris, objects, and pedestrians. The contextual representation may be limited to a maximum range of the sensor array (e.g., 50 meters, 100 meters, or 200 meters) or may be supplemented by information obtained from other sensors in the environment, semantic information known about an area, and/or any other relevant information regardless of the range of the sensor array. The representation of the contextual environment may include information about the agents 104, 112 or other objects within the environment that may be surrounding the vehicle 102, as well as semantic information about the traffic lanes, traffic rules, traffic signs, time of day, weather, and/or any other suitable information. The contextual environment may be represented in any suitable manner. For example, the contextual representation may be encoded as a vector or matrix of numerical values, with each value in the vector/matrix corresponding to a predetermined category of information. As will be further appreciated below, after an autonomy event 210 (e.g., a discomforted braking, a disengagement, a jerk, a change in lateral acceleration, a dramatic decrease to ride smoothness, or a potential collision) with respect to the vehicle 102A is determined, perception data provided by the perception data 204A and/or sensor data 202 may be utilized to continuously capture data about the environment of the vehicle 102A after the autonomy event 210. The data captured after the autonomy event 210 about the environment of the vehicle 102A environment may be used to generate known prediction data and a planned trajectory based on the known prediction data evaluate the prediction module 206 based on a planned trajectory generated based on generated prediction data.

In certain embodiments, the representation of the present contextual environment from the perception data 204A may be consumed by a prediction module 206 to generate one or more predictions of the future environment. For example, given a representation of the contextual environment at time T₀, the prediction module 206 may output another contextual representation for time T₁. For instance, if the T₀ contextual environment may be represented by a raster image, the output of the prediction module 206 may be another raster image (e.g., a snapshot of the current environment) that depicts where the agents 104, 112 would be at time T₁ (e.g., a snapshot of the predicted future). In certain embodiments, prediction module 206 may include a ML model that may be trained based on previously recorded contextual and sensor data. For example, one training sample may be generated based on a sequence of actual sensor data captured by the vehicle 102A at times T₀ and T₁. The captured data at times T₀ and T₁ may be used to generate, respectively, a first contextual representation (the training data) and a second contextual representation (the associated ground-truth used for training). During training, the ML model may process the first contextual representation using the model's current configuration parameters and output a predicted contextual representation. The predicted contextual representation may then be compared to the known second contextual representation (e.g., the ground-truth at time T₁).

In certain embodiments, the comparison may be quantified by a loss value, computed using a loss function. The loss value may be used (e.g., via back-propagation techniques) to update the configuration parameters of the ML model so that the loss would be less if the prediction were to be made again. The ML model may be trained iteratively using a large set of training samples until a convergence or termination condition is met. For example, training may terminate when the loss value is below a predetermined threshold. Once trained, the ML model may be used to generate predictions of future contextual representations based on current contextual representations. The prediction module 206 may utilize any combination of rule-based, ML-based, and/or mechanics models for characterizing the movement of agents 104, 112 over time in order to predict the probabilities of different paths, types of movement, and actions over different time periods for use by the system to predict the movements of agents 104, 112 surrounding the vehicle 102A.

In certain embodiments, the planning module 208 may determine a planned trajectory 214A for the vehicle 102A, including navigation routes and particular driving operations (e.g., slowing down, speeding up, stopping, swerving, and so forth), based on the predicted contextual representation generated by the prediction module 206. In certain embodiments, the planning module 208 may utilize the predicted information encoded within the predicted contextual representation (e.g., predicted location or trajectory of agents 104, 112, semantic data, and so forth) and any other available information (e.g., map data, scenario information, traffic data, accident reports, weather reports, target destinations, and any other suitable information) to determine one or more actions, goals, or navigation instructions for the vehicle 102A over a window of time (e.g., the planned trajectory 214A may be for the next 2, 5, 10, or 15 seconds). For example, based on the predicted behavior of the agents 104, 112 surrounding the vehicle 102A and the traffic data to a particular destination, the planning module 208 may determine a particular navigation path and associated driving operations for the vehicle 102A over a window of time. For example, the path may include a series of waypoints and/or any other suitable set of information for the vehicle 102A to understand the path of movement to following. The path and associated driving operations are generated to avoid possible collisions with one or more agents 104, 112, to follow the traffic laws, and to ensure a safe and comfortable ride for the passengers of the vehicle 102A.

In certain embodiments, the planning module 208 may generate, based on a given predicted contextual representation, several different planned trajectories 214 (e.g., paths, goals or navigation instructions) for the vehicle 102A. For each plan, the planning module 208 may compute a score that represents the desirability of that plan. For example, if the plan would likely result in the vehicle 102A performing a hard stop or otherwise performing an uncomfortable or jarring movement the score for the plan may be penalized accordingly. Another plan that would cause the vehicle 102A to violate traffic rules or take a lengthy detour to avoid possible collisions may also have a score that is penalized, but the penalty may be less severe than the penalty applied. The penalties and scoring of the different potential routes may ensure safe and comfortable paths are generated and selected by the system. For example, a third plan that causes the vehicle 102A to gradually stop or change lanes to avoid an agent 104, 112 the predicted future may receive the highest score compared to paths with jarring movements and/or an increased chance of a collision event. Based on the assigned scores for the plans, the planning module 208 may select the best planned trajectory 214A to carry out. While the example above used collision as an example, the disclosure herein contemplates the use of any suitable scoring criterial, such as travel distance or time, fuel economy, changes to the estimated time of arrival at the destination, passenger comfort, proximity to other vehicles, the confidence score associated with the predicted contextual representation, and so forth.

In certain embodiments, based on the planned trajectory 214A generated by planning module 208, a control module (not illustrated) may determine the specific commands to be issued to the actuators of the vehicle 102A. The actuators of the vehicle 102A are components that are responsible for moving and controlling the vehicle 102A. The actuators control driving functions of the vehicle 102A, such as for example, steering, turn signals, throttle, deceleration (e.g., braking), acceleration, gear shift, and so forth. For example, control module may transmit commands to a steering actuator to maintain a particular steering angle for a particular amount of time to move a vehicle on a particular trajectory. As another example, control module may transmit commands to a throttle actuator to speed the vehicle 102A up or a braking actuator to slow the vehicle 102A down.

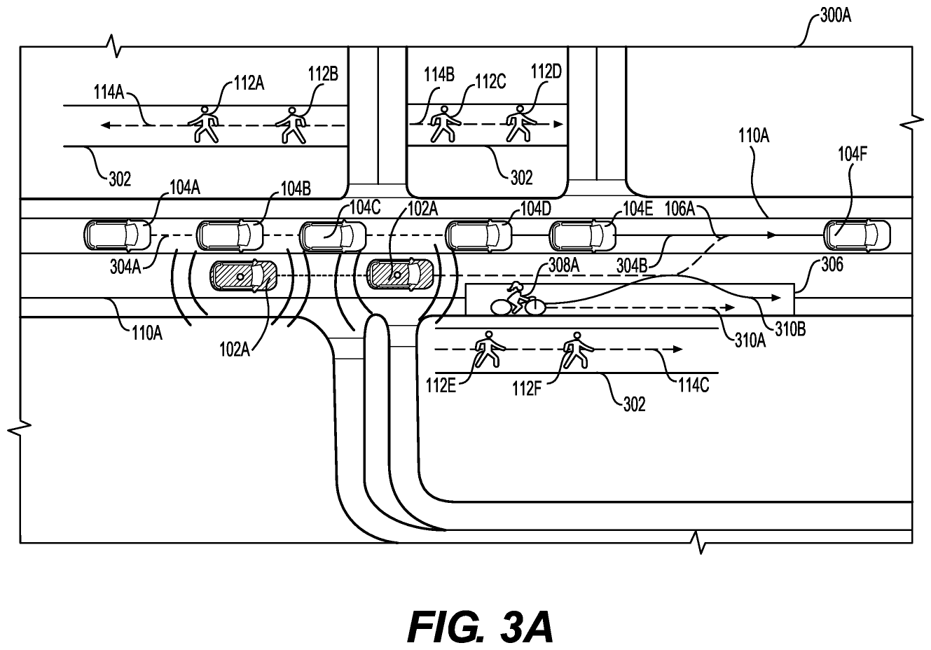

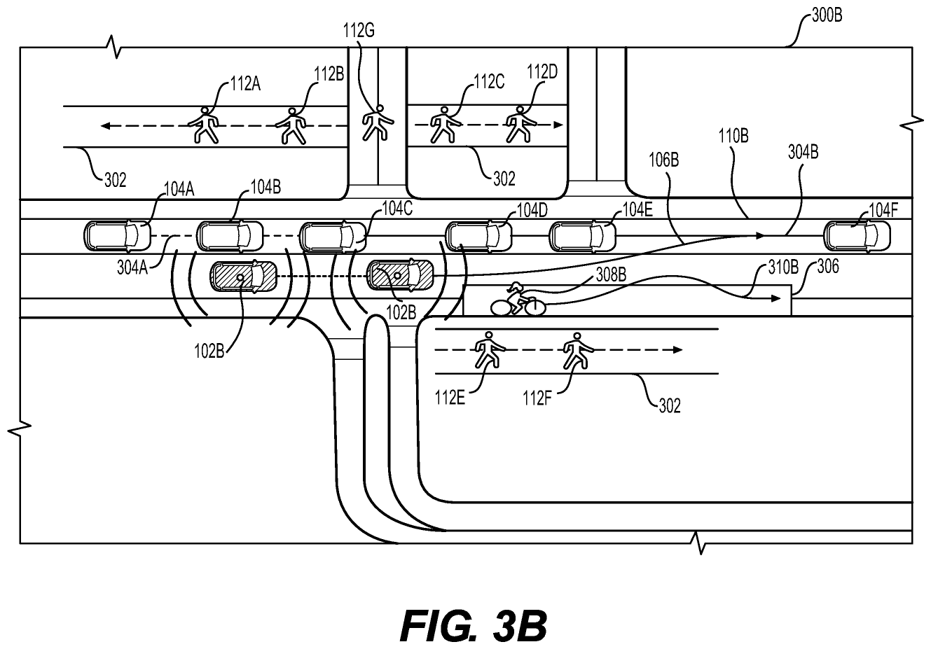

As will be further appreciated below with respect to FIGS. 3A, 3B, 4A, 4B, and 5, known prediction data may be generated by a known prediction module 212 and provided to a planning module 208 to determine what the planning module 208 would perform based on generated or unknown prediction data (e.g., as generated by the prediction module 206) as compared against the known prediction data. For example, as discussed in further detail below, utilizing the determined deviation between the planned trajectory 214A generated based on the generated or unknown prediction data and the planned trajectory 216A generated based on the known prediction data, the present techniques may allow the prediction training framework 200A, 200B to evaluate the performance of the prediction module 206, and to identify particular driving scenarios and particular dynamic agents 104, 112 with respect to the identified driving scenarios for which the prediction module 206 may be improved by additional training of the prediction module 206 (e.g., based on already-known-be-correct prediction data) and to distinguish those from driving scenarios or other agents 104, 112 for which some allowable prediction error or imperfection may have only marginal impact to the trajectory planning performed by the planning module 208. Indeed, by identifying the particular driving scenarios and the particular dynamic agents 104, 112 with respect to those identified driving scenarios for which the prediction module 206 may be improved by errorless or near perfect prediction data and additional training, and by further distinguishing those from driving scenarios or other agents 104, 112 for which some prediction error or imperfection may have only marginal impact to the trajectory planning, the prediction module 206 may be trained specifically based on the particular driving scenarios and the particular dynamic agents 104, 112 with respect to those identified driving scenarios for which the performance of the prediction module 206 may be improved.

For example, as further depicted by FIG. 2A, the prediction training framework 200A may include a known prediction module 212. In certain embodiments, the known prediction module 212 may include one or more machine leaning (ML) algorithms, which may include, for example, one or more deep learning algorithms, supervised learning algorithms, and/or unsupervised learning algorithms. In other embodiments, the known prediction module 212 may include, for example, one or more artificial neural networks (ANNs) that may be utilized to learn deep levels of representations and abstractions from large amounts of perception data 204B. For example, the one or more ANNs may include a multilayer perceptron (MLP), an autoencoder (AE), a convolution neural network (CNN), a recurrent neural network (RNN), long short term memory (LSTM), a grated recurrent unit (GRU), a restricted Boltzmann Machine (RBM), a deep belief network (DBN), a bidirectional recurrent deep neural network (BRDNN), a generative adversarial network (GAN), one or more deep Q-networks, a neural autoregressive distribution estimation (NADE) network, an adversarial network (AN), one or more attentional models (AM), deep reinforcement learning, and so forth.

In certain embodiments, following an autonomy event 210, the known prediction module 212 may access perception data 204B generated based on the sensor data 202 captured by one or more sensors associated with the vehicle 102A. For example, in one embodiment, the perception data 204B may be associated with an environment external to the vehicle 102A, and may correspond to sensor data 202 captured after the point in time corresponding to the autonomy event 210. For example, in certain embodiments, while the vehicle 102A may be operating according to the planned trajectory generated based on the prediction data generated by the prediction module 206, additional sensor data 202 of the environment of the vehicle 102A may be captured. In certain embodiments, the known prediction module 212 may then generate known prediction data (e.g., already-known-be-correct prediction data) with respect to the environment based on perception data corresponding to sensor data 202 captured after the autonomy event 210.

In certain embodiments, the known prediction module 212 may generate the known prediction data by generating, for example, a predicted trajectory for one or more particular agents 104, 112 within the environment of the vehicle 102A. In one embodiment, the known prediction module 212 may determine an amount of time into the future the predicted trajectory for the one or more agents 104, 112 is to extend. In one embodiment, the determined amount of time may include, for example, a prediction horizon (e.g., a determined amount of time into the future for which the known prediction module 212 predicts projected trajectories of agents 104, 112 within a given perceived scene with respect to the vehicle 102A). In some embodiments, the prediction horizon may be set to correspond to, for example, an interval of prediction data expected by the planning module 208 (e.g., approximately 10 seconds). However, because—in some instances—known prediction data may be unsuitable beyond, for example, approximately 5 seconds (e.g., beyond that the environment with respect to a giving driving scenario may deviate too much from the driving scenario of interest to be useful for the training of the prediction module 206), in certain embodiments, the prediction horizon for the known prediction data may be set to, for example, approximately 1 second, 2 seconds, 3 seconds, 4 seconds, or up to approximately 5 seconds. In some embodiments, to ensure a 10-second prediction horizon of prediction data as expected by the planning module 208, the first 5-second interval of a 10-second prediction horizon may include suitable known prediction data, while the second 5-second interval may be padded, for example, as a repeat of the first 5-second interval of known prediction data and/or approximation of what the known prediction data would be beyond approximately 5 seconds.

In certain embodiments, the known prediction module 212 may then output the known prediction data to the planning module 208. Specifically, as noted above, utilizing the perception data 204B generated based on sensor data 202 captured after the autonomy event 210, the known prediction module 212 may generate known prediction data as one or more prediction messages to be provided to the planning module 208 in a form recognizable and consumable by the planning module 208. In one embodiment, the known prediction data may include one or more driving scenarios, which may include, for example, a scene, the vehicle 102A (e.g., including the location and rotation data of the vehicle 102A), all of the agents 104, 112 (e.g., including class labels and position information), traffic lights, and traffic signs detected around the vehicle 102A within the scene, projected trajectories for one or more agents 104, 112 around the vehicle 102A, lane sequences and associations, contextual environment data, and/or other data that may be associated with the vehicle 102A at or about the time of the autonomy event 210 (e.g., a discomforted braking, a disengagement, a jerk, a change in lateral acceleration, a dramatic decrease to ride smoothness, or a potential collision).

In certain embodiments, based on the known prediction data, the planning module 208 may generate a planned trajectory 216A for the vehicle 102A utilized to evaluate the impact that the known prediction data has on the trajectory planning of the planning module 208, and to identify which driving scenarios may be improved by additional training of the prediction module 206. In certain embodiments, a difference between the planned trajectory 214A and the planned trajectory 216A may be determined. For example, in one embodiment, the prediction training framework 200A may determine differences between the planned trajectory 214A and the planned trajectory 216A by comparing one or more of, for example, velocity parameters, acceleration parameters, braking parameters, steering angle parameters, jerk parameters, average distance parameters, lateral acceleration parameters, spatiotemporal overlap parameters, average violation of traffic laws parameters, gap selection parameters, disengagement parameters, progress in the route parameters, parameters expressing a proportion of driving scenarios in which the planning module 208 performs different behavior for the known prediction data generated by the known prediction module 212 as compared to the prediction data generated by the prediction module 206, latitudinal distance parameters, longitudinal distance parameters, a ride smoothness parameters, and so forth. In one embodiment, the prediction training framework 200A, 200B may determine differences between the planned trajectory 214A and the planned trajectory 216A based on path planning parameters (e.g., one or more driving parameters, one or more driving maneuvers, one or more particular driving environments, one or more particular driving scenarios, and so forth) that may be held constant, such that the prediction training framework 200A, 200B may isolate the evaluation of the prediction module 206 to simply whether or not the prediction module 206 may be improved by increased prediction accuracy (e.g., already-known-be-correct prediction data) and/or the evaluation of the planning module 208 to simply whether or not the planning module 208 may lead to an undesirable autonomy event (e.g., hard-braking, disengagement, potential collision) based on the increased prediction accuracy (e.g., already-known-be-correct prediction data).

In certain embodiments, the determined differences between the planned trajectory 214A and the planned trajectory 216A may be used to derive one or evaluation criteria 218 that may be utilized to evaluate the planned trajectory 214A generated based on prediction data generated by the prediction module 206 and the planned trajectory 216A generated by the known prediction module 212. For example, in one embodiment, the derived evaluation criteria 218 may include, for example, a discomforted braking score, a disengagement score, or a collision score that may be utilized to evaluate and score the planned trajectory 214A and the planned trajectory 216A. In another embodiment, in addition to the discomforted braking score, the disengagement score, and the collision score, the derived evaluation criteria 218 may also include, for example, a similarity to human driving score, a legality score, a passenger comfort score, a fuel range score, a charge range score, a safety score, or any of various other evaluation criteria that may be utilized to evaluate and score the planned trajectory 214A and the planned trajectory 216A. In certain embodiments, the derived evaluation criteria 218 may also include or provide some indication, for example, of an evaluation of the planning module 208. For example, in some embodiments, if the planning module 208 performs similarly with respect to utilizing the known prediction data as the planning module 208 performs with respect to utilizing the generated prediction data, then the derived evaluation criteria 218 provides indication that the planning module 208 may benefit from additional training with respect to the particular driving scenario and/or one or more particular agents associated with the particular driving scenario.

In certain embodiments, in response to determining that the difference fails to satisfy predetermined prediction criteria (e.g., determined based on the discomforted braking score, the disengagement score, the collision score, and so forth), the prediction training framework 200A may identify the driving scenario and the planned trajectory 216A, as well as identify one or more agents 104, 112 within the environment for which the prediction module 206 underperforms to update the prediction module 206 based on the identified one or more agents 104, 112 and the contextual environment data associated with the driving scenario. For example, in one embodiment, the prediction training framework 200A may identify the one or more agents 104, 112 for which the prediction module 206 underperforms by identifying at least one dynamic agent 104, 112 for which the prediction module 206 underperforms by a greatest amount with respect to a number of dynamic agents 104, 112 identified within a scene. Thus, the prediction training framework 200A may evaluate the performance of the prediction module 206 by identifying particular driving scenarios and particular dynamic agents 104, 112 with respect to the identified driving scenarios for which the prediction module 206 may be improved by increased prediction accuracy (e.g., already-known-be-correct prediction data) and to distinguish those from driving scenarios or other dynamic agents 104, 112 for which some allowable prediction error or imperfection may have only marginal impact to the trajectory planning performed by the planning module 208. In certain embodiments, the identified particular driving scenarios and the particular dynamic agents 104, 112 with respect to those identified particular driving scenarios for which the prediction module 206 may be improved by known or near perfect prediction data may be provided through a feedback loop 220 to the prediction module 206 to train the prediction module 206 based on the particular driving scenarios and the particular dynamic agents 104, 112 with respect to those identified driving scenarios.

Turning now to FIG. 2B, in certain embodiments, following the autonomy event 210, the known prediction module 212 may access perception data 204B generated based on the sensor data 202 captured by one or more sensors associated with the vehicle 102A. As previously discussed, the perception data 204B may be associated with an environment external to the vehicle 102A, and may correspond to sensor data 202 captured after the point in time corresponding to the autonomy event 210. In certain embodiments, as further depicted by FIG. 2B, the perception data 204B may also include one or more simulated agents 222 that may be injected into the perception data 204B, deleted from the perception data 204B, and/or exchanged to replace one or more real-world dynamic agents 104, 112 that may be present in the scene. For example, in some embodiments, the simulated agents 222 may include, for example, various dynamic agents 104, 112 (e.g., vehicles, cyclists, pedestrian, joggers, and so forth) that may be injected into the perception data 204B, such that the known prediction module 212 may generate known prediction data based on both the perception data 204B (e.g., real-world perception data) and the simulated agents 222 for isolated evaluation and training of the prediction module 206.

For example, in certain embodiments, as will be further appreciated below with respect to FIGS. 3A, 3B, 4A, 4B, and 5, the prediction training framework 200B may generate evaluations or scores 218 that indicate what the planning module 208 would perform for a giving driving scenario and/or neighboring driving scenarios if, for example, the dynamic agent(s) 104, 112 in the scene of the vehicle 102A is: 1) another vehicle, 2) a cyclist, 3) a pedestrian, 4) a jogger, 5) one or more combinations of vehicles, cyclists, pedestrians, joggers, and so forth, 6) additional vehicles, cyclists, pedestrians, and joggers to increase complexity of the scene, and so forth. That is, by adjusting and altering the perception data 204B input to the known prediction module 212, the known prediction module 212 may generate differing and varying known prediction messages that may be either combined or isolated for more granular determination of the effect the differing and varying known prediction data may have on the trajectory planning of the planning module 208 for a more granular and isolated evaluation of the prediction module 206.

In certain embodiments, as further depicted by FIG. 2A, the known prediction module 212 may receive as input the perception data 204B and any simulated agents 222, as well as the prediction data generated by the prediction module 206. Based on the perception data 204B, the simulated agents 222, and/or the prediction data generated by the prediction module 206, the known prediction module 212 may generate known prediction data (e.g., already-known-be-correct prediction data). In some embodiments, the known prediction module 212 may generate known prediction data based on only the perception data 204B, based only on the perception data 204B and the simulated agents 222, based only on the prediction data generated by the prediction module 206 and the simulated agents 222, and/or some combination of the perception data 204B, the simulated agents 222, and the prediction data generated by the prediction module 206. For example, in one embodiment, the known prediction module 212 may select between one or more combinations of the perception data 204B, the simulated agents 222, and the prediction data generated by the prediction module 206 based on a predetermined prediction data filtering criteria.

In certain embodiments, the known prediction module 212 may include a set of prediction data filtering criteria (e.g., programmable by developers), which may include, for example, a type of agent 104, 112 (e.g., vehicle versus cyclist versus pedestrian), perception data 204B tracking identification (ID) data, prediction horizon with respect to one or more agents 104, 112, type of agent 104, 112 per driving scenario, lane sequences and associations with respect to one or more agents 104, 112, length of predicted trajectory with respect to one or more agents 104, 112, and/or any of various criteria that may be defined by developers for generating differing planned trajectories 216B for isolated and granular evaluation of the prediction module 206. In one embodiment, the prediction data filtering criteria may be determined per agent 104, 112 and/or per type agent 104, 112, such that the known prediction module 212 may select between utilizing differing combinations of the perception data 204B, the simulated agents 222, and/or the prediction data generated by the prediction module 206 for each agent 104, 112 of interest and/or for each type of agent 104, 112 of interest (e.g., agent 104, 112 in the immediate vicinity of the vehicle 102A) within a scene.

In certain embodiments, the known prediction module 212 may further adjust or alter the perception data 204B, the simulated agents 222, and/or the prediction data generated by the prediction module 206. For example, in some embodiments, the known prediction module 212 may introduce jitter (e.g., random noise that may be added to the perception data 204B, the simulated agents 222, and/or the prediction data generated by the prediction module 206) to the predicted trajectory for one or more agents 104, 112 of interest (e.g., agent 104, 112 in the immediate vicinity of the vehicle 102A) with respect to a particular driving scenario to determine an accuracy to sensitivity ratio between the prediction module 206 and the planning module 208. For example, in one embodiment, to evaluate and train the prediction module 206 to better predict mercurial behavior of one or more agents 104, 112, the known module 212 may cause, for example, a pedestrian agent 112 to suddenly dash into a crosswalk, a jogger agent 112 to run faster, a vehicle agent 104 to straddle a lane boundary, a cyclist agent to ride outside the boundaries of a bicycle lane, and/or other random noise to the projected trajectory of one or more agents 104, 112 of interest (e.g., agent 104, 112 in the immediate vicinity of the vehicle 102A) to evaluate and train the prediction module 206 to better predict mercurial behavior of one or more agents 104, 112, for example.

In certain embodiments, the known prediction module 212 may then output the known prediction data to the planning module 208. Specifically, based on only the perception data 204B, based only on the perception data 204B and the simulated agents 222, based only on the prediction data generated by the prediction module 206 and the simulated agents 222, and/or some combination of the perception data 204B, the simulated agents 222, and the prediction data generated by the prediction module 206, the known prediction module 212 may generate known prediction data as one or more prediction messages to be provided to the planning module 208 in a form recognizable and consumable by the planning module 208. In one embodiment, the known prediction data may include one or more driving scenarios, which may include, for example, a scene, the vehicle 102A (e.g., including the location and rotation data of the vehicle 102A), all of the agents 104, 112 (e.g., including class labels and position information), traffic lights, and traffic signs detected in the immediate vicinity of the vehicle 102A within the scene, projected trajectories for one or more agents 104, 112 in the immediate vicinity of the vehicle 102A, projected trajectories for one or more simulated agents 222, lane sequences and associations, contextual environment data, and/or other data that may be associated with the vehicle 102A at or about the time of the autonomy event 210 (e.g., a discomforted braking, a disengagement, a jerk, a change in lateral acceleration, a dramatic decrease to ride smoothness, or a potential collision).

In certain embodiments, based on the known prediction data, the planning module 208 may generate a planned trajectory 216B for the vehicle 102A utilized to evaluate the impact that the known prediction data has on the trajectory planning of the planning module 208, and to identify which driving scenarios may be improved by additional training of the prediction module 206. In certain embodiments, a difference between the planned trajectory 214B and the planned trajectory 216B may be determined. For example, in one embodiment, the prediction training framework 200B may determine differences between the planned trajectory 216B and the planned trajectory 216B by comparing one or more of, for example, velocity parameters, acceleration parameters, braking parameters, steering angle parameters, jerk parameters, average distance parameters, lateral acceleration parameters, spatiotemporal overlap parameters, average violation of traffic laws parameters, gap selection parameters, disengagement parameters, progress in the route parameters, parameters expressing a proportion of driving scenarios in which the planning module 208 performs different behavior for the known prediction data generated by the known prediction module 212 as compared to the prediction data generated by the prediction module 206, latitudinal distance parameters, longitudinal distance parameters, a ride smoothness parameters, and so forth.

In certain embodiments, the determined differences between the planned trajectory 214B and the planned trajectory 216B may be used to derive one or evaluation criteria 218 that may be utilized to evaluate the planned trajectory 214B generated based on prediction data generated by the prediction module 206 and the planned trajectory 216B generated by the known prediction module 212. For example, in one embodiment, the derived evaluation criteria 218 may include, for example, a discomforted braking score, a disengagement score, or a collision score that may be utilized to evaluate and score the planned trajectory 214B and the planned trajectory 216B. In another embodiment, in addition to the discomforted braking score, the disengagement score, and the collision score, the derived evaluation criteria 218 may also include, for example, a similarity to human driving score, a legality score, a passenger comfort score, a fuel range score, or any of various other evaluation criteria that may be utilized to evaluate and score the planned trajectory 214B and the planned trajectory 216B.

In certain embodiments, in response to determining that the difference fails to satisfy predetermined prediction criteria (e.g., determined based on the discomforted braking score, the disengagement score, the collision score, and so forth), the prediction training framework 200B may identify the driving scenario and the planned trajectory 216B, as well as identify one or more agents 104, 112 within the environment for which the prediction module 206 underperforms to update the prediction module 206 based on the identified one or more agents 104, 112 and the contextual environment data associated with the driving scenario. For example, in one embodiment, the prediction training framework 200B may identify the one or more agents 104, 112 for which the prediction module 206 underperforms by identifying at least one dynamic agent 104, 112 for which the prediction module 206 underperforms by a greatest amount with respect to a number of other dynamic agents 104, 112 identified within a scene.

In other embodiments, in response to determining that the difference fails to satisfy predetermined prediction (e.g., determined based on the discomforted braking score, the disengagement score, the collision score, and so forth), the prediction training framework 200B may identify—based on the known prediction data and the planned trajectory 216B—a set or a subset of dynamic agents 104, 112 for which the prediction module 206 underperforms by a greatest amount with respect to some other dynamic agents 104, 112 identified within a scene. In certain embodiments, the prediction training framework 200B may then update the prediction module 206 by providing a prediction training dataset to the prediction module 206 through the feedback loop 220 to train the prediction module 206 to generate prediction data so as to reduce, for example, the difference between planned trajectory 214B and the planned trajectory 216B.

In certain embodiments, in response to determining that the difference fails to satisfy predetermined prediction criteria (e.g., determined based on the discomforted braking score, the disengagement score, the collision score, and so forth), the prediction training framework 200A may identify the driving scenario and the planned trajectory 216B, as well as identify one or more agents 104, 112 and/or simulated agents 222 within the environment for which the prediction module 206 underperforms to update the prediction module 206 based on the identified one or more agents 104, 112 and the contextual environment data associated with the driving scenario. For example, in one embodiment, the prediction training framework 200B may identify the one or more agents 104, 112 for which the prediction module 206 underperforms by identifying at least one dynamic agent 104, 112 and/or simulated agents 222 for which the prediction module 206 underperforms by a greatest amount with respect to a number of other dynamic agents 104, 112 identified within a scene. Thus, the prediction training framework 200B may evaluate the performance of the prediction module 206 by identifying particular driving scenarios and particular dynamic agents 104, 112 and/or simulated agents 222 with respect to the identified driving scenarios for which the prediction module 206 may be improved by increased prediction accuracy (e.g., already-known-be-correct prediction data) and to distinguish those from driving scenarios or other dynamic agents 104, 112 and/or simulated agents 222 for which some allowable prediction error or imperfection may have only marginal impact to the trajectory planning performed by the planning module 208. In certain embodiments, the identified particular driving scenarios and the particular dynamic agents 104, 112 and/or simulated agents 222 with respect to those identified particular driving scenarios for which the prediction module 206 may be improved by known or near perfect prediction data may be provided through a feedback loop 220 to the prediction module 206 to train the prediction module 206 based on the particular driving scenarios and the particular dynamic agents 104, 112 and/or simulated agents 222 with respect to those identified driving scenarios.

FIG. 3A and FIG. 3B illustrate one or more running examples of driving scenarios 300A and 300B in which known prediction data may be generated by a known prediction module and provided to a planning module to generate a planned trajectory that may be utilized for the evaluation and training of the base prediction module. Specifically, FIGS. 3A and 3B illustrate one or more running examples of autonomous-driving mode scenarios 300A and 300B in which the vehicle 102A has a planned trajectory 106A based on generated predicted data with respect to vehicle agents 104A, 104B, 104C, 104D, 104E, and 104F, pedestrian agents 112A, 112B, 112C, 112D, 112E, and 112F, and a cyclist agent 308A, in accordance with the presently disclosed embodiments. In certain embodiments, as illustrated by the example driving scenario 300A of FIG. 3A, the vehicle 102A may perceive the vehicle agents 104A-104F traveling in the lane of the roadway 110A opposite that of the vehicle 102A, pedestrian agents 112A-112F walking on sidewalks 302, and the cyclist agent 308A riding within a bicycle lane 306 along the roadway 110A. In certain embodiments, the vehicle 102A may generate predicted trajectories 114A, 114B, and 114C for the pedestrian agents 112A-112F each traveling straight and a constant velocity along the sidewalks 302, predicted trajectories 304A for the vehicle agents 104A-104F each traveling straight and at a constant velocity along the roadway 110A, and a predicted trajectory 310A for the cyclist 308A traveling straight and at a constant velocity within the bicycle lane 306.

In certain embodiments, based on the predicted trajectories 114A, 114B, and 114C, the predicted trajectories 304A, and the predicted trajectory 310A, the vehicle 102A may generate a planned trajectory 106A, which may include a constant velocity and a varying steering angle to perform a lane change to overtake the vehicle agent 104E. In accordance with the presently disclosed embodiments, a known predicted trajectory 304B for the vehicle agents 104E and 104F and a known predicted trajectory for the cyclist agent 308A may be generated, for example, by the known prediction module 212 (e.g., based on perception data generated after an autonomy event occurs). For example, as further depicted in FIG. 3A, because the cyclist agent 308A may have temporarily veered outside of the bicycle lane 306 and into the roadway 110A, an autonomy event (e.g., a discomforted braking, a disengagement) may occur at a point during the planned trajectory 106A in which the vehicle 102A, for example, is approaching the cyclist agent 308A having veered outside of the bicycle lane 306. In such a case, a supervisory driver of the vehicle 102A may have disengaged and/or the autonomous compute system of the vehicle 102A may have performed a discomforted braking (e.g., a hard-braking) to avoid a potential collision with the cyclist agent 308A having deviated from the predicted trajectory 310A.

In certain embodiments, as illustrated by the example simulated driving scenario 300B of FIG. 3B, the planned trajectory 106B for the vehicle 102B may include a constant velocity and a gradually changing steering angle as compared to the planned trajectory 106A, such that the vehicle 102B may travel a constant velocity while performing a gradual merger into the opposite lane of the roadway 110B. Specifically, the planned trajectory 106B may be generated by the known planning module 208 based on known prediction data (e.g., prediction data already known be correct) with respect to the known predicted trajectory 310B for the cyclist agent 308B and the known predicted trajectory 304B for the vehicle agents 104C-104E. In accordance with the presently disclosed embodiments, based on the prediction data already known be correct (e.g., known predicted trajectory 310B and known predicted trajectory 304B), the planning module 208 may generate a planned trajectory 106B that includes a constant velocity and a gradually changing steering angle, such that vehicle 102B may perform the gradual merger into the opposite lane of the roadway 110B and thus avoids the cyclist agent 308A. As it may be further appreciated from the driving scenario 300B, even though the known prediction data may include a pedestrian agent 112G determined to be in the crosswalk as opposed to the sidewalk 302, because the pedestrian agent 112G is not traveling (e.g., walking, jogging) into the drive path of the vehicle 102B along roadway 110B, any known predicted data with respect to the pedestrian agent 112G may be determined as not being materially and adversely impactful to the planned trajectory 106B generated by the planning module 208 based on the known prediction data. Thus, utilizing the determined deviation between the planned trajectory 108A and the planned trajectory 108B, the driving scenario 300B (e.g., the planned trajectory 106B for the vehicle 102B and with and respect to the known predicted trajectories 310B and 304B for the vehicle agents 104C-104E and the cyclist 308B) may be introduced to a prediction training dataset for additional training of the prediction module 206.

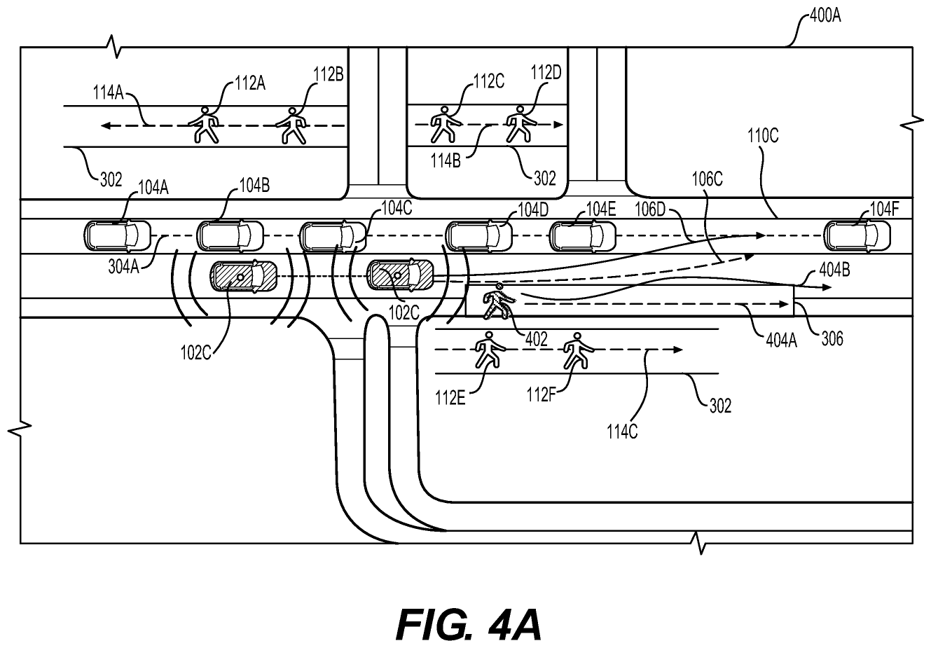

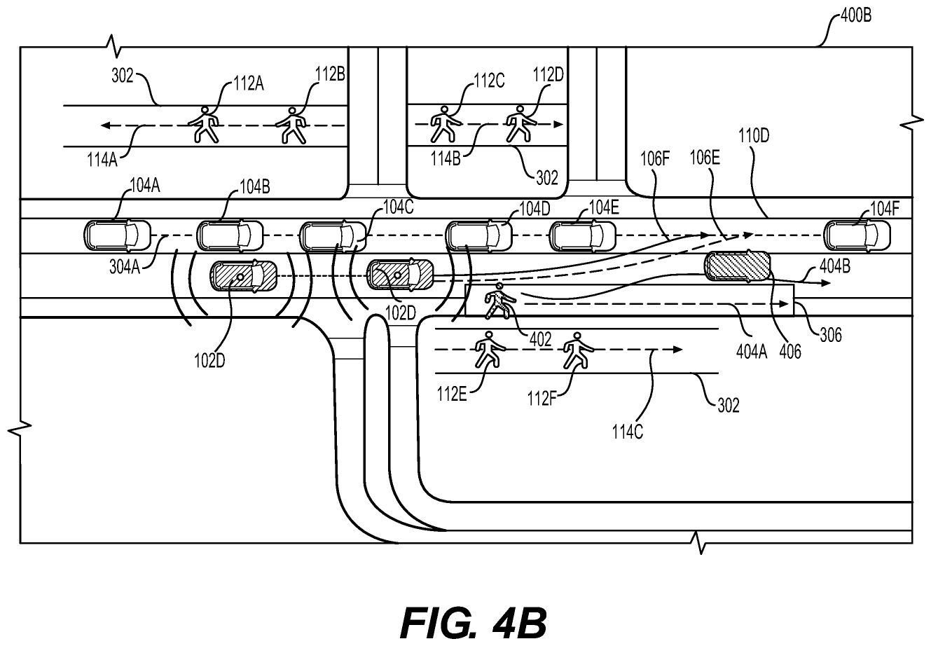

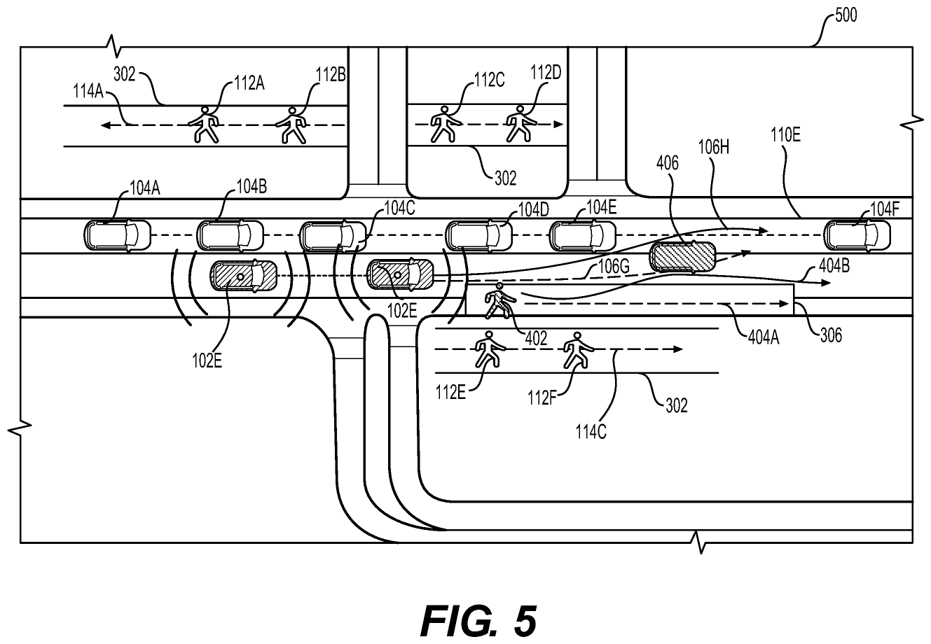

FIG. 4A, FIG. 4B, and FIG. 5 illustrate one or more running examples of driving scenarios 400A, 400B, and 500 in which known prediction data and one or more simulated agents may be generated by a known prediction module and provided to a planning module to generate a planned trajectory that may be utilized for the evaluation and training of the base prediction module. Specifically, FIGS. 4A, 4B, and 5 illustrate one or more running examples of autonomous-driving mode scenarios 400A, 400B, and 500 in which the cyclist agent 308A, 308B discussed above may be replaced with a jogger agent 402 (e.g., simulated agent injected into the driving scenario) and additional vehicle agent 406 (e.g., simulated agent injected into the driving scenario) to illustrate impact to the planned trajectory based on agent type, in accordance with the presently disclosed embodiments. In certain embodiments, based on the predicted trajectories 114A, 114B, and 114C, the predicted trajectories 304A, and the predicted trajectory 404A, the vehicle 102C may generate a planned trajectory 106C, which may include a constant velocity and a varying steering angle to perform a lane change to overtake the vehicle agent 104E. In accordance with the presently disclosed embodiments, a known predicted trajectory 304B for the vehicle agents 104E and 104F and a known predicted trajectory for the jogger agent 402 may be generated, for example, by the known prediction module 212 (e.g., based on perception data generated after an autonomy event occurs). For example, as further depicted in FIG. 4A, because the jogger agent 402 may have wandered outside of the bicycle lane 306 and into the roadway 110C, an autonomy event (e.g., a discomforted braking, a disengagement) may occur at a point during the planned trajectory 106C in which the vehicle 102C, for example, is approaching the cyclist agent 308A having veered outside of the bicycle lane 306. In such a case, a supervisory driver of the vehicle 102C may have disengaged and/or the autonomous compute system of the vehicle 102A may have performed a discomforted braking (e.g., a hard-braking) to avoid a potential collision with the jogger agent 402 having deviated from the predicted trajectory 404A.

In certain embodiments, as further illustrated, the planned trajectory 106D for the vehicle 102D may include a constant velocity and a gradually changing steering angle as compared to the planned trajectory 106C, such that the vehicle 102D may travel a constant velocity while performing a gradual merger into the opposite lane of the roadway 110C. As depicted, the planned trajectory 106D and the planned trajectory 106C would each safely lead to the lane merger without any collision with the jogger agent 402, and thus, for example, the known prediction module 212 may determine that the known predicted trajectory 310B for the cyclist agent 308B may materially impact the planned trajectory 106B for the vehicle 102B by a greater amount as compared to, for example, the known predicted trajectory 404B for the jogger agent 402.

In certain embodiments, in the driving scenario 400B of FIG. 4B, another vehicle agent 406 may be injected into the driving scenario 400B. As depicted, the vehicle agent 406 may be traveling straight and at a constant velocity within the same lane of the roadway 110D as the vehicle 102D. As further depicted, the known planned trajectory 106F for the vehicle 102D may include a constant velocity and a sharper gradual changing to the steering angle as compared to the planned trajectory 106E, such that the vehicle 102D may travel a constant velocity while performing a sharper gradual merger into the opposite lane of the roadway 110D. As depicted, the planned trajectory 106E and the known planned trajectory 106F would each safely lead to the lane merger without any collision with the jogger agent 402, the vehicle agent 406, or the vehicle agent 104E, and thus, for example, the known prediction module 212 may determine that the present driving scenario 400B would only marginally impact the trajectory planning of the planning module 208. Thus, even though the prediction module 206 did not predict the predicted trajectory 404A for the jogger agent 402 as well as the known prediction module 212 predicted the known predicted trajectory 404B, the prediction training framework 200B, for example, may determine that the prediction module 206 performs well (e.g., discomforted braking, disengagement not warranted) for the driving scenario 400B.

In certain embodiments, in the driving scenario 500 of FIG. 5, the vehicle agent 406 may be injected into the driving scenario 500. As depicted, the vehicle agent 406 may be merging into the lane opposite the lane of the roadway 110E in which the vehicle 102E is merging into. As further depicted, the known planned trajectory 106G for the vehicle 102E may include a constant velocity and markedly sharper gradual changing to the steering angle as compared to the planned trajectory 106H. As depicted, neither the planned trajectory 106G nor the known planned trajectory 106G for the vehicle 102E would appear to safely lead to the lane merger without some degree of a discomforted braking and/or a disengagement with respect to the vehicle agent 406 and/or jogger agent 402, and thus, for example, the known prediction module 212 may determine that the present driving scenario 500 would markedly impact the trajectory planning of the planning module 208. Thus, the prediction training framework 200B, for example, may determine that the prediction module 206 underperforms for the particular driving scenario 500 and with respect to the jogger agent 402 and the vehicle agent 406. The driving scenario 500 may be introduced to a prediction training dataset for additional training of the prediction module 206.

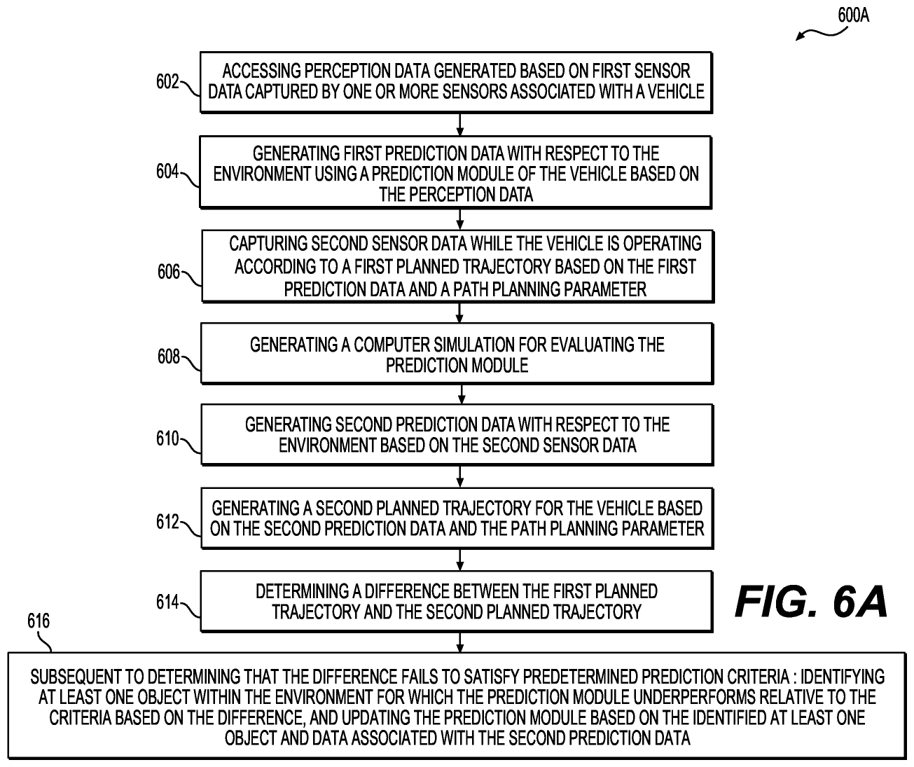

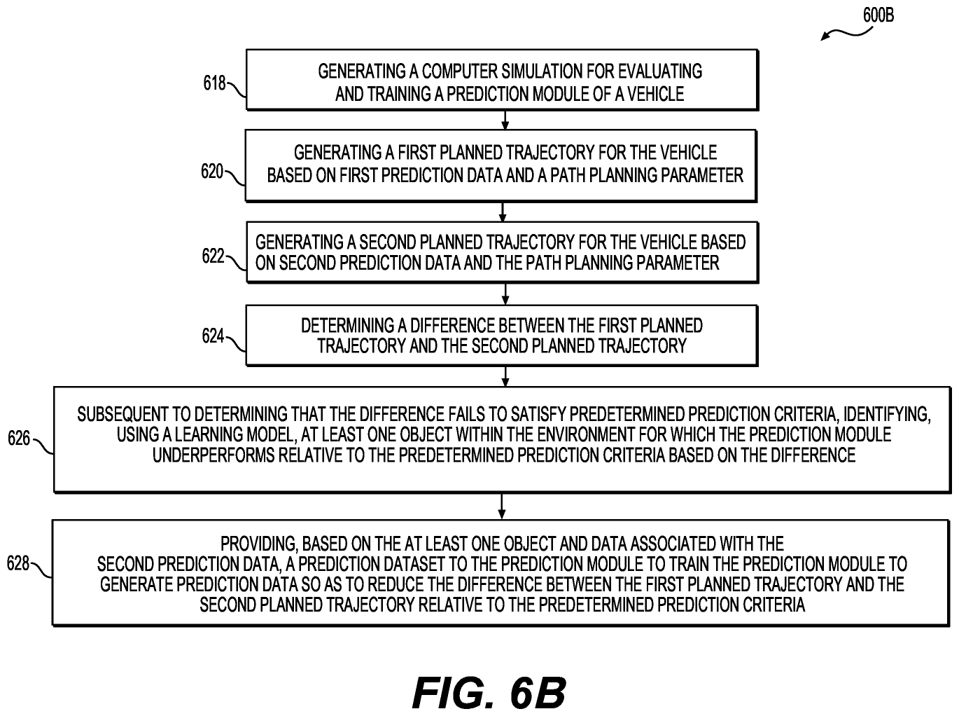

FIG. 6A illustrates a flow diagram of a method 600A for generating known prediction data and providing to a planning module to generate a planned trajectory that may be utilized for the evaluation and training of the base prediction module, in accordance with the presently disclosed techniques. The method 600A may be performed utilizing one or more processing devices (e.g., prediction training framework 200A, 200B) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 600A may begin at block 602 with one or more processing devices (e.g., prediction training framework 200A, 200B) accessing perception data generated based on first sensor data captured by one or more sensors associated with a vehicle, wherein the perception data is associated with an environment external of the vehicle. The method 600A may then continue at block 604 with the one or more processing devices (e.g., prediction training framework 200A, 200B) generating first prediction data with respect to the environment using a prediction module of the vehicle based on the perception data. The method 600A may then continue at block 606 with the one or more processing devices (e.g., prediction training framework 200A, 200B) capturing second sensor data of the environment using the one or more sensors associated with the vehicle while the vehicle is operating according to a first planned trajectory based on the first prediction data, wherein the first planned trajectory is generated based on the first prediction data and a path planning parameter associated with the environment. The method 600A may then continue at block 608 with the one or more processing devices (e.g., prediction training framework 200A, 200B) generating a computer simulation for evaluating the prediction module.

The method 600A may continue at block 610 with the one or more processing devices (e.g., prediction training framework 200A, 200B) generating second prediction data with respect to the environment based on the second sensor data. The method 600A may continue at block 612 with the one or more processing devices (e.g., prediction training framework 200A, 200B), based on the second prediction data and the path planning parameter associated with the environment, generating a second planned trajectory for the vehicle. The method 600A may continue at block 614 with the one or more processing devices (e.g., prediction training framework 200A, 200B) determining a difference between the first planned trajectory and the second planned trajectory. The method 600A may conclude at block 616 with the one or more processing devices (e.g., prediction training framework 200A, 200B), subsequent to determining that the difference fails to satisfy predetermined prediction criteria, identifying, based on the second prediction data and the second planned trajectory, at least one object within the environment for which the prediction module underperforms, and updating the prediction module based on the identified at least one object and data associated with the second prediction data.

Accordingly, as described by the method 600A of FIG. 6A, the present techniques include an offline prediction training framework that utilizes perception data captured after a point in time (e.g., in the future) in which an online prediction module generates prediction data, and generates known prediction data (e.g., prediction data already known be correct) based thereon. The known prediction module may provide the known prediction data to a planning module to determine what the planning module would perform based on generated prediction data (as generated by the base prediction module) as compared against the known prediction data. Thus, utilizing the determined deviation between the planned trajectory generated based on the generated or unknown prediction data and the planned trajectory generated based on the known prediction data, the present techniques may allow developers to evaluate the performance of the base prediction module, and to determine one or more driving scenarios for which the prediction module may include additional training to improve the performance of the prediction module. In certain embodiments, the known prediction module may also allow developers to alter or supplement one or more aspects of the input perception data in order to further evaluate the prediction module. For example, the known prediction module may evaluate the performance of agent-specific prediction modules with respect to each of a number of different agent types (e.g., vehicle versus pedestrian versus cyclist, etc.) and their respective positions with respect to the vehicle. The known prediction module may also allow developers to alter the prediction data consumed by the planning module to evaluate its impact on the planning module, as measured by a predetermined metric (e.g., a discomforted braking, a disengagement, or a potential collision) in order to determine exactly how accurate the prediction data may be to prevent an undesirable autonomy event, such as a discomforted braking or a disengagement. The known prediction module may also identify certain driving scenarios to be introduced to a training dataset for the prediction module by evaluating which of an aggregate set of driving scenarios included inaccurate predictions that may materially affect the planning module to generate trajectories with an adverse impact to a predetermined metric (e.g., collision, discomforted braking, disengagement).

Indeed, in certain embodiments, the prediction training framework may access perception data generated based on first sensor data captured by one or more sensors associated with a vehicle. For example, in one embodiment, the perception data may be associated with an environment external of the vehicle. The prediction training framework may then generate first prediction data with respect to the environment using a prediction module of the vehicle based on the perception data. In certain embodiments, while the vehicle is operating according to a first planned trajectory based on the first prediction data, the prediction training framework may then capture second sensor data of the environment by using the one or more sensors associated with the vehicle. In certain embodiments, the prediction training framework may then generate second prediction data (e.g., already-known-be-correct prediction data) with respect to the environment based on the second sensor data. In certain embodiments, the prediction training framework may then generate a second planned trajectory for the vehicle based on the second prediction data. In certain embodiments, the prediction training framework may generate the second prediction data by generating a predicted trajectory for a first object within the environment. For example, in one embodiment, the prediction training framework may determine an amount of time into the future the predicted trajectory for the first object is to extend and generate the second planned trajectory for the vehicle based on the determined amount of time. Further, in one embodiment, in generating the second planned trajectory, the prediction training framework may select between the first prediction data, the second prediction data, or a combination of the first prediction data and the second data based on a predetermined prediction data filtering criteria.

In certain embodiments, the prediction training framework may then determine a difference between the first planned trajectory and the second planned trajectory. In certain embodiments, in response to determining that the difference fails to satisfy predetermined prediction (e.g., determined based on a braking parameter, a disengagement parameter, a jerk parameter, a lateral acceleration parameter, a ride smoothness parameter, or a collision parameter), the prediction training framework may identify, based on the second prediction data and the second planned trajectory, a first object within the environment for which the prediction module underperforms and update the prediction module based on the identified first object and data associated with the second prediction data. For example, in one embodiment, the prediction system may identify the first object by identifying a dynamic object of a number of dynamic objects identified within the environment for which the prediction module underperforms by a greatest amount.

In other embodiments, in response to determining that the difference fails to satisfy predetermined prediction criteria, the prediction training framework may also identify, based on the second prediction data and the second planned trajectory, a second object within the environment for which the prediction system underperforms. For example, in some embodiments, the prediction training framework may determine that the prediction module underperforms by a greater amount with respect to the first object than with respect to the second object and update the prediction module based on the first object and the data associated with the second prediction data. In one embodiment, the prediction training framework may update the prediction module by providing a prediction training dataset to the prediction module to train the prediction module to generate prediction data so as to reduce the difference between the first planned trajectory and the second planned trajectory.

In certain embodiments, the prediction training framework may also generate third prediction data with respect to the environment based on the second sensor data and first simulated data. For example, in one embodiment, the third prediction data may include prediction data associated with a first object. The prediction training framework may then generate a third planned trajectory for the vehicle based on the third prediction data. In certain embodiments, the prediction training framework may then generate fourth prediction data with respect to the environment based on the second sensor data and second simulated data. For example, in one embodiment, the fourth prediction data may include prediction data associated with a second object different from the first object. The prediction training framework may then generate a fourth planned trajectory for the vehicle based on the fourth prediction data and determine a difference between the third planned trajectory and the fourth planned trajectory. In certain embodiments, in response to determining that the difference between the third planned trajectory and the fourth planned trajectory fails to satisfy the predetermined prediction criteria (e.g., one of the third planned trajectory or the fourth planned may have resulted in a discomforted braking, a disengagement, or a potential collision), identifying one of the first object or the second object for which the prediction module underperforms by a greatest amount. In one embodiment, the first simulated data may include a first jitter adjustment with respect to the first object and the second simulated data may include a second jitter adjustment with respect to the second object. In certain embodiments, the prediction training framework may utilize at least one of the first jitter adjustment or the second jitter adjustment to determine an accuracy to sensitivity ratio between the prediction module and a planning module of the vehicle.

In this way, the present techniques provide an offline prediction training framework that utilizes perception data captured after a point in time (e.g., in the future) in which an online generated or unknown prediction system generates prediction data, and generates known prediction data (e.g., prediction data already known be correct) based thereon. The known prediction system may provide the known prediction data to a planning module to determine what the planning module would perform based on generated or unknown prediction data (as generated by the traditional prediction system) as compared against the known prediction data. Thus, utilizing the determined deviation between the planned trajectory generated based on the generated or unknown prediction data and the planned trajectory generated based on the known prediction data, the present techniques may allow the prediction training framework to evaluate the performance of the prediction module, and to identify particular driving scenarios and particular dynamic agents with respect to the identified driving scenarios for which the prediction module may be improved by increased prediction accuracy (e.g., already-known-be-correct prediction data) and to distinguish those from driving scenarios or other agents for which some allowable prediction error or imperfection may have only marginal impact to the trajectory planning performed by the planning module. Indeed, by identifying the particular driving scenarios and the particular dynamic agents with respect to those identified driving scenarios for which the prediction system may be improved by errorless or near perfect prediction data, and by further distinguishing those from driving scenarios or other agents for which some prediction error or imperfection may have only marginal impact to the trajectory planning, the prediction system may be trained based on the particular driving scenarios and the particular dynamic agents with respect to those identified driving scenarios for which the performance of the prediction system may be improved.

FIG. 6B illustrates a flow diagram of a method 600B for generating known prediction data and providing to a planning module to generate a planned trajectory that may be utilized for the learning, evaluation, and training of the base prediction module, in accordance with the presently disclosed techniques. The method 600B may be performed utilizing one or more processing devices (e.g., prediction training framework 200A, 200B) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 600B may begin at block 618 with one or more processing devices (e.g., prediction training framework 200A, 200B) generating a computer simulation for evaluating and training a prediction module of a vehicle. The method 600B may then continue at block 620 with the one or more processing devices (e.g., prediction training framework 200A, 200B) generating a first planned trajectory based on first prediction data and a path planning parameter. The method 600B may then continue at block 622 with the one or more processing devices (e.g., prediction training framework 200A, 200B) generating a second planned trajectory based on second prediction data and the path planning parameter. The method 600B may then continue at block 624 with the one or more processing devices (e.g., prediction training framework 200A, 200B) determining a difference between the first planned trajectory and the second planned trajectory. The method 600B may then continue at block 626 with the one or more processing devices (e.g., prediction training framework 200A, 200B), subsequent to determining that the difference between the first planned trajectory and the second planned trajectory fails to satisfy predetermined prediction criteria, identifying, using a learning model, at least one object within the environment for which the prediction module underperforms relative to predetermined prediction criteria based on the difference. The method 600B may then continue at block 628 with the one or more processing devices (e.g., prediction training framework 200A, 200B), providing, based on the least one object and data associated with the second prediction data, a prediction dataset to the prediction module to train the prediction module to generate prediction data so as to reduce the first planned trajectory and the second planned trajectory relative to the predetermined prediction criteria.

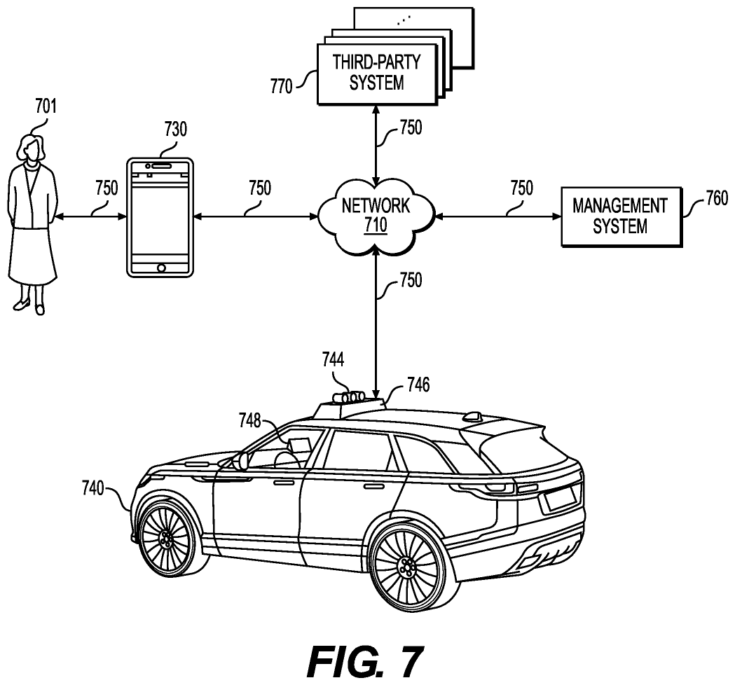

FIG. 7 illustrates an example block diagram of a transportation management environment that may be utilized to perform one or more of the forgoing embodiments as discussed herein. In certain embodiments, the environment may include various computing entities, such as a user computing device 730 of a user 701 (e.g., a ride provider or requestor), a transportation management system 760, an autonomous or semi-autonomous vehicle 740, and one or more third-party system 770. The computing entities may be communicatively connected over any suitable network 710. For example, one or more portions of network 710 may include an ad hoc network, an extranet, a virtual private network (VPN), a local area network (LAN), a wireless LAN (WLAN), a wide area network (WAN), a wireless WAN (WWAN), a metropolitan area network (MAN), a portion of the Internet, a portion of Public Switched Telephone Network (PSTN), a cellular network, or a combination of any of the above. In certain embodiments, any suitable network arrangement and protocol enabling the computing entities to communicate with each other may be used. Although FIG. 7 illustrates a single user device 730, a single transportation management system 760, a single vehicle 740, a plurality of third-party systems 770, and a single network 710, this disclosure contemplates any suitable number of each of these entities. For example, the network environment may include multiple users 701, user devices 730, transportation management system 760, autonomous or semi-autonomous vehicles 740, third-party systems 770, and networks 710.

The user device 730, transportation management system 760, autonomous or semi-autonomous vehicle 740, and third-party system 770 may be communicatively connected or co-located with each other in whole or in part. These computing entities may communicate via different transmission technologies and network types. For example, the user device 730 and the vehicle 740 may communicate with each other via a cable or short-range wireless communication (e.g., Bluetooth, NFC, WI-FI, and so forth), and together they may be connected to the Internet via a cellular network that is accessible to either one of the devices (e.g., the user device 730 may be a smartphone with LTE connection). The transportation management system 760 and third-party system 770, on the other hand, may be connected to the Internet via their respective LAN/WLAN networks and Internet Service Providers (ISP).

FIG. 7 illustrates transmission links 750 that connect user device 730, autonomous or semi-autonomous vehicle 740, transportation management system 760, and third-party system 770 to communication network 710. This disclosure contemplates any suitable transmission links 750, including, e.g., wire connections (e.g., USB, Lightning, Digital Subscriber Line (DSL) or Data Over Cable Service Interface Specification (DOCSIS)), wireless connections (e.g., WI-FI, WiMAX, cellular, satellite, NFC, Bluetooth), optical connections (e.g., Synchronous Optical Networking (SONET), Synchronous Digital Hierarchy (SDH)), any other wireless communication technologies, and any combination thereof. In certain embodiments, one or more links 750 may connect to one or more networks 710, which may include in part, e.g., ad-hoc network, the Intranet, extranet, VPN, LAN, WLAN, WAN, WWAN, MAN, PSTN, a cellular network, a satellite network, or any combination thereof. The computing entities may not necessarily use the same type of transmission link 750. For example, the user device 730 may communicate with the transportation management system via a cellular network and the Internet but communicate with the autonomous vehicle 740 via Bluetooth or a physical wire connection.

In certain embodiments, the transportation management system 760 may fulfill ride requests for one or more users 701 by dispatching suitable vehicles. The transportation management system 760 may receive any number of ride requests from any number of ride requestors 701. In certain embodiments, a ride request from a ride requestor 701 may include an identifier that identifies the ride requestor in the system 760. The transportation management system 760 may utilize the identifier to access and store the ride requestor's 701 information, in accordance with the requestor's 701 privacy settings. The ride requestor's 701 information may be stored in one or more data stores (e.g., a relational database system) associated with and accessible to the transportation management system 760. In certain embodiments, ride requestor information may include profile information about a particular ride requestor 701.

In certain embodiments, the ride requestor 701 may be associated with one or more categories or types, through which the ride requestor 701 may be associated with aggregate information about certain ride requestors of those categories or types. Ride information may include, for example, preferred pick-up and drop-off locations, driving preferences (e.g., safety comfort level, preferred speed, rates of acceleration/deceleration, safety distance from other vehicles when traveling at various speeds, route, and so forth), entertainment preferences and settings (e.g., preferred music genre or playlist, audio volume, display brightness, and so forth), temperature settings, whether conversation with the driver is welcomed, frequent destinations, historical riding patterns (e.g., time of day of travel, starting and ending locations, and so forth), preferred language, age, gender, or any other suitable information. In certain embodiments, the transportation management system 760 may classify a user 701 based on known information about the user 701 (e.g., using ML classifiers), and use the classification to retrieve relevant aggregate information associated with that class. For example, the system 760 may classify a user 701 as a young adult and retrieve relevant aggregate information associated with young adults, such as the type of music generally preferred by young adults.

Transportation management system 760 may also store and access ride information. Ride information may include locations related to the ride, traffic data, route options, optimal pick-up or drop-off locations for the ride, or any other suitable information associated with a ride. For example, when the transportation management system 760 receives a request to travel from San Francisco International Airport (SFO) to Palo Alto, Calif., the system 760 may access or generate any relevant ride information for this particular ride request. The ride information may include, for example, preferred pick-up locations at SFO; alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason; one or more routes to navigate from SFO to Palo Alto; preferred off-ramps for a type of user; or any other suitable information associated with the ride.

In certain embodiments, portions of the ride information may be based on historical data associated with historical rides facilitated by the system 760. For example, historical data may include aggregate information generated based on past ride information, which may include any ride information described herein and telemetry data collected by sensors in autonomous vehicles and/or user devices. Historical data may be associated with a particular user (e.g., that particular user's preferences, common routes, and so forth), a category/class of users (e.g., based on demographics), and/or all users of the system 760. For example, historical data specific to a single user may include information about past rides that particular user has taken, including the locations at which the user is picked up and dropped off, music the user likes to listen to, traffic information associated with the rides, time of the day the user most often rides, and any other suitable information specific to the user. As another example, historical data associated with a category/class of users may include, e.g., common or popular ride preferences of users in that category/class, such as teenagers preferring pop music, ride requestors who frequently commute to the financial district may prefer to listen to the news, and so forth.

As yet another example, historical data associated with all users may include general usage trends, such as traffic and ride patterns. Using historical data, the system 760 in certain embodiments may predict and provide ride suggestions in response to a ride request. In certain embodiments, the system 760 may utilize machine-learning, such as neural networks, regression algorithms, instance-based algorithms (e.g., k-Nearest Neighbor), decision-tree algorithms, Bayesian algorithms, clustering algorithms, association-rule-learning algorithms, deep-learning algorithms, dimensionality-reduction algorithms, ensemble algorithms, and any other suitable ML algorithms known to persons of ordinary skill in the art. The ML models may be trained using any suitable training algorithm, including supervised learning based on labeled training data, unsupervised learning based on unlabeled training data, and/or semi-supervised learning based on a mixture of labeled and unlabeled training data.

In certain embodiments, transportation management system 760 may include one or more server computers. Each server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In certain embodiments, each server may include hardware, software, or embedded logic components or a combination of two or more such components for carrying out the appropriate functionalities implemented or supported by the server.

In certain embodiments, transportation management system 760 may include one or more data stores. The data stores may be used to store various types of information, such as ride information, ride requestor information, ride provider information, historical information, third-party information, or any other suitable type of information. In certain embodiments, the information stored in the data stores may be organized according to specific data structures. In certain embodiments, each data store may be a relational, columnar, correlation, or any other suitable type of database system. Although this disclosure describes or illustrates particular types of databases, this disclosure contemplates any suitable types of databases. Certain embodiments may provide interfaces that enable a user device 730 (which may belong to a ride requestor or provider), a transportation management system 760, vehicle system 740, or a third-party system 770 to process, transform, manage, retrieve, modify, add, or delete the information stored in the data store.

In certain embodiments, transportation management system 760 may include an authorization server (or any other suitable component(s)) that allows users 701 to opt-in to or opt-out of having their information and actions logged, recorded, or sensed by transportation management system 760 or shared with other systems (e.g., third-party systems 770). In certain embodiments, a user 701 may opt-in or opt-out by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users 701 of transportation management system 760 through blocking, data hashing, anonymization, or other suitable techniques as appropriate.

In certain embodiments, third-party system 770 may be a network-addressable computing system that may provide HD maps or host GPS maps, customer reviews, music or content, weather information, or any other suitable type of information. Third-party system 770 may generate, store, receive, and send relevant data, such as, for example, map data, customer review data from a customer review website, weather data, or any other suitable type of data. Third-party system 770 may be accessed by the other computing entities of the network environment either directly or via network 710. For example, user device 730 may access the third-party system 770 via network 710, or via transportation management system 760. In the latter case, if credentials are to be accessed the third-party system 770, the user 701 may provide such information to the transportation management system 760, which may serve as a proxy for accessing content from the third-party system 770.

In certain embodiments, user device 730 may be a mobile computing device such as a smartphone, tablet computer, or laptop computer. User device 730 may include one or more processors (e.g., CPU and/or GPU), memory, and storage. An operating system and applications may be installed on the user device 730, such as, e.g., a transportation application associated with the transportation management system 760, applications associated with third-party systems 770, and applications associated with the operating system. User device 730 may include functionality for determining its location, direction, or orientation, based on integrated sensors such as GPS, compass, gyroscope, or accelerometer. User device 730 may also include wireless transceivers for wireless communication and may support wireless communication protocols such as Bluetooth, near-field communication (NFC), infrared (IR) communication, WI-FI, and/or 2G/3G/4G/LTE/5G mobile communication standard. User device 730 may also include one or more cameras, scanners, touchscreens, microphones, speakers, and any other suitable input-output devices.

In certain embodiments, the vehicle 740 may be an autonomous or semi-autonomous vehicle and equipped with an array of sensors 744, a navigation system 746, and a ride-service computing device 748. In certain embodiments, a fleet of autonomous or semi-autonomous vehicles 740 may be managed by the transportation management system 760. The fleet of autonomous vehicles 740, in whole or in part, may be owned by the entity associated with the transportation management system 760, or they may be owned by a third-party entity relative to the transportation management system 760. In either case, the transportation management system 760 may control the operations of the autonomous vehicles 740, including, e.g., dispatching select vehicles 740 to fulfill ride requests, instructing the vehicles 740 to perform select operations (e.g., head to a service center or charging/fueling station, pull over, stop immediately, self-diagnose, lock/unlock compartments, change music station, change temperature, and any other suitable operations), and instructing the vehicles 740 to enter select operation modes (e.g., operate normally, drive at a reduced speed, drive under the command of human operators, and any other suitable operational modes).

In certain embodiments, the autonomous or semi-autonomous vehicles 740 may receive data from and transmit data to the transportation management system 760 and the third-party system 770. Example of received data may include, e.g., instructions, new software or software updates, maps, 3D models, trained or untrained ML models, location information (e.g., location of the ride requestor, the autonomous or semi-autonomous vehicle 740 itself, other vehicles 740, and target destinations such as service centers), navigation information, traffic information, weather information, entertainment content (e.g., music, video, and news) ride requestor information, ride information, and any other suitable information. Examples of data transmitted from the autonomous or semi-autonomous vehicle 740 may include, e.g., telemetry and sensor data, determinations/decisions based on such data, vehicle condition or state (e.g., battery/fuel level, tire and brake conditions, sensor condition, speed, odometer, and so forth), location, navigation data, passenger inputs (e.g., through a user interface in the vehicle 740, passengers may send/receive data to the transportation management system 760 and/or third-party system 770), and any other suitable data.

In certain embodiments, autonomous or semi-autonomous vehicles 740 may also communicate with each other as well as other traditional human-driven vehicles, including those managed and not managed by the transportation management system 760. For example, one vehicle 740 may communicate with another vehicle data regarding their respective location, condition, status, sensor reading, and any other suitable information. In certain embodiments, vehicle-to-vehicle communication may take place over direct short-range wireless connection (e.g., WI-FI, Bluetooth, NFC) and/or over a network (e.g., the Internet or via the transportation management system 760 or third-party system 770).

In certain embodiments, an autonomous or semi-autonomous vehicle 740 may obtain and process sensor/telemetry data. Such data may be captured by any suitable sensors. For example, the vehicle 740 may have a LiDAR sensor array of multiple LiDAR transceivers that are configured to rotate 360°, emitting pulsed laser light and measuring the reflected light from objects surrounding vehicle 740. In certain embodiments, LiDAR transmitting signals may be steered by use of a gated light valve, which may be a MEMs device that directs a light beam using the principle of light diffraction. Such a device may not use a gimbaled mirror to steer light beams in 360° around the autonomous or semi-autonomous vehicle. Rather, the gated light valve may direct the light beam into one of several optical fibers, which may be arranged such that the light beam may be directed to many discrete positions around the autonomous or semi-autonomous vehicle. Thus, data may be captured in 360° around the autonomous or semi-autonomous vehicle, but no rotating parts may be necessary. A LiDAR is an effective sensor for measuring distances to targets, and as such may be used to generate a 3D model of the external environment of the autonomous or semi-autonomous vehicle 740. For example, the 3D model may represent the external environment including objects such as other cars, curbs, debris, objects, and pedestrians up to a maximum range of the sensor arrangement (e.g., 50 meters, 100 meters, or 200 meters).

As another example, the autonomous or semi-autonomous vehicle 740 may have optical cameras pointing in different directions. The cameras may be used for, e.g., recognizing roads, lane markings, street signs, traffic lights, police, other vehicles, and any other visible objects of interest. To enable the vehicle 740 to “see” at night, infrared cameras may be installed. In certain embodiments, the vehicle may be equipped with stereo vision for, e.g., spotting hazards such as pedestrians or tree branches on the road. As another example, the vehicle 740 may have radars for, e.g., detecting other vehicles and/or hazards afar. Furthermore, the vehicle 740 may have ultrasound equipment for, e.g., parking and obstacle detection. In addition to sensors enabling the vehicle 740 to detect, measure, and understand the external world around it, the vehicle 740 may further be equipped with sensors for detecting and self-diagnosing the vehicle's own state and condition. For example, the vehicle 740 may have wheel sensors for, e.g., measuring velocity; global positioning system (GPS) for, e.g., determining the vehicle's current geolocation; and/or inertial measurement units, accelerometers, gyroscopes, and/or odometer systems for movement or motion detection.

While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieved using any combination of sensors. For example, an autonomous vehicle 740 may build a 3D model of its surrounding based on data from its LiDAR, radar, sonar, and cameras, along with a pre-generated map obtained from the transportation management system 760 or the third-party system 770. Although sensors 744 appear in a particular location on autonomous vehicle 740 in FIG. 7, sensors 744 may be located in any suitable location in or on the autonomous or semi-autonomous vehicle 740. Example locations for sensors include the front and rear bumpers, the doors, the front windshield, on the side panel, or any other suitable location.

In certain embodiments, the autonomous vehicle 740 may be equipped with a processing unit (e.g., one or more CPUs and GPUs), memory, and storage. The vehicle 740 may thus be equipped to perform a variety of computational and processing tasks, including processing the sensor data, extracting useful information, and operating accordingly. For example, based on images captured by its cameras and a machine-vision model, the vehicle 740 may identify particular types of objects captured by the images, such as pedestrians, other vehicles, lanes, curbs, and any other objects of interest. In certain embodiments, the autonomous vehicle 740 may have a navigation system 746 responsible for safely navigating the autonomous vehicle 740. In certain embodiments, the navigation system 746 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. The navigation system 746 may also utilize, e.g., map data, traffic data, accident reports, weather reports, instructions, target destinations, and any other suitable information to determine navigation routes and particular driving operations (e.g., slowing down, speeding up, stopping, swerving, and so forth). In certain embodiments, the navigation system 746 may utilize its determinations to control the vehicle 740 to operate in prescribed manners and to guide the autonomous vehicle 740 to its destinations without colliding into other objects. Although the physical embodiment of the navigation system 746 (e.g., the processing unit) appears in a particular location on autonomous vehicle 740 in FIG. 7, navigation system 746 may be located in any suitable location in or on autonomous vehicle 740. Example locations for navigation system 746 include inside the cabin or passenger compartment of autonomous vehicle 740, near the engine/battery, near the front seats, rear seats, or in any other suitable location.

In certain embodiments, the autonomous or semi-autonomous vehicle 740 may be equipped with a ride-service computing device 748, which may be a tablet computer, or any other suitable device installed by transportation management system 760 to allow the user to interact with the autonomous vehicle 740, transportation management system 760, other users 701, or third-party systems 770. In certain embodiments, installation of ride-service computing device 748 may be accomplished by placing the ride-service computing device 748 inside autonomous vehicle 740, and further configuring it to communicate with the vehicle 740 via a wire or wireless connection (e.g., via Bluetooth). Although FIG. 7 illustrates a single ride-service computing device 748 at a particular location in autonomous vehicle 740, autonomous or semi-autonomous vehicle 740 may include several ride-service computing devices 748 in several different locations within the vehicle.

For example, the autonomous or semi-autonomous vehicle 740 may include four ride-service computing devices 748 located in the following places: one in front of the front-left passenger seat (e.g., driver's seat in traditional U.S. automobiles), one in front of the front-right passenger seat, one in front of each of the rear-left and rear-right passenger seats. In certain embodiments, ride-service computing device 748 may be detachable from any component of autonomous vehicle 740. This may allow users to handle ride-service computing device 748 in a manner consistent with other tablet computing devices. For example, a user may move ride-service computing device 748 to any location in the cabin or passenger compartment of the autonomous or semi-autonomous vehicle 740, may hold ride-service computing device 748, or handle ride-service computing device 748 in any other suitable manner. Although this disclosure describes providing a particular computing device in a particular manner, this disclosure contemplates providing any suitable computing device in any suitable manner.

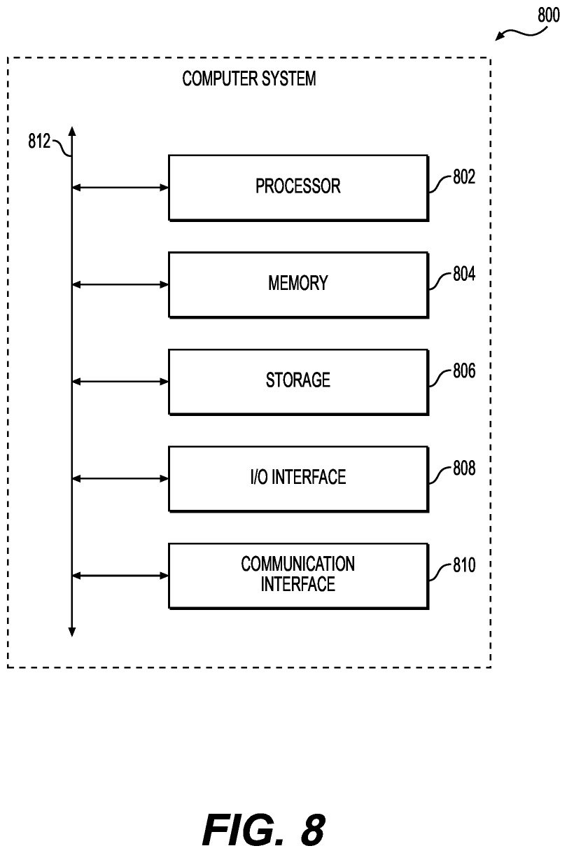

FIG. 8 illustrates an example computer system 800 that may be utilized to perform one or more of the forgoing embodiments as discussed herein. In certain embodiments, one or more computer systems 800 perform one or more steps of one or more methods described or illustrated herein. In certain embodiments, one or more computer systems 800 provide the functionalities described or illustrated herein. In certain embodiments, software running on one or more computer systems 800 performs one or more steps of one or more methods described or illustrated herein or provides the functionalities described or illustrated herein. Certain embodiments include one or more portions of one or more computer systems 800. Herein, a reference to a computer system may encompass a computing device, and vice versa, where appropriate. Moreover, a reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. For example, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In certain embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement. In certain embodiments, processor 802 includes hardware for executing instructions, such as those making up a computer program. For example, to execute instructions, processor 802 may retrieve (or fetch) the instructions from an internal register, an internal cache, memory 804, or storage 806; decode and execute them; and then write one or more results to an internal register, an internal cache, memory 804, or storage 806. In certain embodiments, processor 802 may include one or more internal caches for data, instructions, or addresses.

This disclosure contemplates processor 802 including any suitable number of any suitable internal caches, where appropriate. For example, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 that are to be operated on by computer instructions; the results of previous instructions executed by processor 802 that are accessible to subsequent instructions or for writing to memory 804 or storage 806; or any other suitable data. The data caches may speed up read or write operations by processor 802. The TLBs may speed up virtual-address translation for processor 802. In certain embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs), be a multi-core processor, or include one or more processors 802. Although this disclosure describes and illustrates a particular processor, this disclosure contemplates any suitable processor.

In certain embodiments, memory 804 includes main memory for storing instructions for processor 802 to execute or data for processor 802 to operate on. For example, computer system 800 may load instructions from storage 806 or another source (such as another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804.

In certain embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described in further detail below. In certain embodiments, one or more memory management units (MMUs) reside between processor 802 and memory 804 and facilitate accesses to memory 804 requested by processor 802. In certain embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In certain embodiments, storage 806 includes mass storage for data or instructions. For example, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In certain embodiments, storage 806 is non-volatile, solid-state memory. In certain embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In certain embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. For example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In certain embodiments, communication interface 810 includes hardware, software, or both providing one or more interfaces for communication (such as, for example, packet-based communication) between computer system 800 and one or more other computer systems 800 or one or more networks. For example, communication interface 810 may include a network interface controller (NIC) or network adapter for communicating with an Ethernet or any other wire-based network or a wireless NIC (WNIC) or wireless adapter for communicating with a wireless network, such as a WI-FI network. This disclosure contemplates any suitable network and any suitable communication interface 810 for it. For example, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or any other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In certain embodiments, bus 812 includes hardware, software, or both coupling components of computer system 800 to each other. As an example and not by way of limitation, bus 812 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (such as field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain embodiments as providing particular advantages, certain embodiments may provide none, some, or all of these advantages.

1. A method comprising, by a computing system:
accessing perception data generated based on first sensor data captured by one or more sensors associated with a vehicle, wherein the perception data is associated with an environment external of the vehicle;
generating first prediction data with respect to the environment using a prediction module based on the perception data;
capturing second sensor data of the environment using the one or more sensors associated with the vehicle while the vehicle is operating according to a first planned trajectory based on the first prediction data, wherein the first planned trajectory is generated based on the first prediction data and a path planning parameter associated with the environment; and
generating a computer simulation for evaluating the prediction module, wherein the generating comprises:
generating second prediction data with respect to the environment based on the second sensor data;
based on the second prediction data and the path planning parameter associated with the environment, generating a second planned trajectory for the vehicle; and
subsequent to determining that a difference between the first planned trajectory and the second planned trajectory fails to satisfy predetermined prediction criteria:
identifying, based on the second prediction data and the second planned trajectory, at least one object within the environment for which the prediction module underperforms relative to the predetermined prediction criteria based on the difference; and
updating the prediction module based on the identified at least one object and data associated with the second prediction data.

2. The method of claim 1, wherein identifying, based on the second prediction data and the second planned trajectory, the at least one object comprises identifying at least one dynamic object of a plurality of dynamic objects within the environment for which the prediction module underperforms by a greatest amount of the difference relative to the predetermined prediction criteria.

3. The method of claim 1, wherein generating the second prediction data comprises generating a predicted trajectory for the at least one object, the method further comprising:
determining an amount of time into the future the predicted trajectory is to extend; and
generating the second planned trajectory for the vehicle based on the determined amount of time into the future the predicted trajectory is to extend.

4. The method of claim 3, wherein the determined amount of time comprises a first time period, the method further comprising:
determining a point in time during the first time period beyond which the predicted trajectory is susceptible to deviating from the second prediction data and the path planning parameter associated with the environment in a manner unsuitable to be utilized for updating the prediction module, the first point in time defining a second determined amount of time into the future the predicted trajectory is to extend; and
generating the second planned trajectory for the vehicle based on the second determined amount of time into the future the predicted trajectory is to extend.

5. The method of claim 1, further comprising:
generating third prediction data with respect to the environment based at least in part on the second sensor data and first simulated data, wherein the third prediction data comprises prediction data associated with a first object;
generating a third planned trajectory for the vehicle based on the third prediction data;
generating fourth prediction data with respect to the environment based at least in part on the second sensor data and second simulated data, wherein the fourth prediction data comprises prediction data associated with a second object different from the first object;
generating a fourth planned trajectory for the vehicle based on the fourth prediction data;
determining a difference between the third planned trajectory and the fourth planned trajectory;
determining that the difference between the third planned trajectory and the fourth planned trajectory fails to satisfy the predetermined prediction criteria; and
determining an accuracy of the prediction module with respect to the first simulated data and the second simulated data based on the difference.

6. The method of claim 5, wherein the first simulated data comprises a first jitter adjustment with respect to the first object and wherein the second simulated data comprises a second jitter adjustment with respect to the second object, the first jitter adjustment and the second jitter adjustment corresponding to one or more random noise parameters configured to alter the third prediction data and the fourth prediction data, respectively.

7. The method of claim 6, further comprising:
determining an accuracy to sensitivity ratio between the prediction module and a planning module of the vehicle based at least in part on the first jitter adjustment or the second jitter adjustment.

8. The method of claim 1, further comprising:
prior to generating the second planned trajectory, selecting between the first prediction data and the second prediction data based on a predetermined prediction data filtering criteria; and
generating the second planned trajectory for the vehicle based on the selection.

9. The method of claim 1, wherein updating the prediction module comprises providing a prediction training dataset to the prediction module to train the prediction module to generate prediction data so as to reduce the difference between the first planned trajectory and the second planned trajectory relative to the predetermined prediction criteria.

10. The method of claim 1, wherein the predetermined prediction criteria is determined based on at least one of a braking parameter, a disengagement parameter, a jerk parameter, a lateral acceleration parameter, a ride smoothness parameter, or a collision parameter.

11. A system, comprising:
one or more non-transitory computer-readable storage media including instructions; and
one or more processors coupled to the storage media, the one or more processors configured to execute the instructions to: access perception data generated based on first sensor data captured by one or more sensors associated with a vehicle, wherein the perception data is associated with an environment external of the vehicle;
generate first prediction data with respect to the environment using a prediction module based on the perception data;
capture second sensor data of the environment using the one or more sensors associated with the vehicle while the vehicle is operating according to a first planned trajectory based on the first prediction data, wherein the first planned trajectory is generated based on the first prediction data and a path planning parameter associated with the environment; and
generate a computer simulation for evaluating the prediction module, wherein to generate comprises:
generate second prediction data with respect to the environment based on the second sensor data;
based on the second prediction data and the path planning parameter associated with the environment, generate a second planned trajectory for the vehicle; and
subsequent to determining that a difference between the first planned trajectory and the second planned trajectory fails to satisfy predetermined prediction criteria:
identify, based on the second prediction data and the second planned trajectory, at least one object within the environment for which the prediction module underperforms relative to the predetermined prediction criteria based on the difference; and
update the prediction module based on the identified at least one object and data associated with the second prediction data.

12. The system of claim 11, wherein to identify the at least one object, the one or more processors being further configured to execute the instructions to identify at least one dynamic object of a plurality of dynamic objects within the environment for which the prediction module underperforms by a greatest amount of the difference relative to the predetermined prediction criteria.

13. The system of claim 11, wherein to generate the second prediction data, the one or more processors being further configured to execute the instructions to:
determine an amount of time into the future the predicted trajectory is to extend; and
generate the second planned trajectory for the vehicle based on the determined amount of time into the future the predicted trajectory is to extend.

14. The system of claim 13, wherein the determined amount of time comprises a first time period, the one or more processors being further configured to execute the instructions to:
determine a point in time during the first time period beyond which the predicted trajectory is susceptible to deviating from the second prediction data and the path planning parameter associated with the environment in a manner unsuitable to be utilized for updating the prediction module, the first point in time defining a second determined amount of time into the future the predicted trajectory is to extend; and
generate the second planned trajectory for the vehicle based on the second determined amount of time into the future the predicted trajectory is to extend.

15. The system of claim 11, the one or more processors being further configured to execute the instructions to:
generate third prediction data with respect to the environment based at least in part on the second sensor data and first simulated data, wherein the third prediction data comprises prediction data associated with a first object;
generate a third planned trajectory for the vehicle based on the third prediction data;
generate fourth prediction data with respect to the environment based at least in part on the second sensor data and second simulated data, wherein the fourth prediction data comprises prediction data associated with a second object different from the first object;
generate a fourth planned trajectory for the vehicle based on the fourth prediction data;
determine a difference between the third planned trajectory and the fourth planned trajectory;
determine that the difference between the third planned trajectory and the fourth planned trajectory fails to satisfy the predetermined prediction criteria; and
determine an accuracy of the prediction module with respect to the first simulated data and the second simulated data based on the difference.

16. The system of claim 15, wherein the first simulated data comprises a first jitter adjustment with respect to the first object and wherein the second simulated data comprises a second jitter adjustment with respect to the second object, the first jitter adjustment and the second jitter adjustment corresponding to one or more random noise parameters configured to alter the third prediction data and the fourth prediction data, respectively.

17. The system of claim 16, the one or more processors being further configured to execute the instructions to:
determine an accuracy to sensitivity ratio between the prediction module and a planning module of the vehicle based at least in part on the first jitter adjustment or the second jitter adjustment.

18. The system of claim 11, the one or more processors being further configured to execute the instructions to:
prior to generating the second planned trajectory, select between the first prediction data and the second prediction data based on a predetermined prediction data filtering criteria; and
generate the second planned trajectory for the vehicle based on the selection.

19. The system of claim 11, wherein to update the prediction module, the one or more processors being further configured to execute the instructions to provide a prediction training dataset to the prediction module to train the prediction module to generate prediction data so as to reduce the difference between the first planned trajectory and the second planned trajectory relative to the predetermined prediction criteria.

20. A non-transitory computer-readable medium comprising instructions that, when executed by one or more processors of a computing device, cause the one or more processors to:
access perception data generated based on first sensor data captured by one or more sensors associated with a vehicle, wherein the perception data is associated with an environment external of the vehicle;
generate first prediction data with respect to the environment using a prediction module based on the perception data;
capture second sensor data of the environment using the one or more sensors associated with the vehicle while the vehicle is operating according to a first planned trajectory based on the first prediction data, wherein the first planned trajectory is generated based on the first prediction data and a path planning parameter associated with the environment; and
generate a computer simulation for evaluating the prediction module, wherein to generate comprises:
generate second prediction data with respect to the environment based on the second sensor data;
based on the second prediction data and the path planning parameter associated with the environment, generate a second planned trajectory for the vehicle; and
subsequent to determining that a difference between the first planned trajectory and the second planned trajectory fails to satisfy predetermined prediction criteria:
identify, based on the second prediction data and the second planned trajectory, at least one object within the environment for which the prediction module underperforms relative to the predetermined prediction criteria based on the difference, and
update the prediction module based on the identified at least one object and data associated with the second prediction data.
